(19) United States
(12) Patent Application Publication
(10) Pub. No.: US 2025/0200464 A1
(43) Pub. Date: Jun. 19, 2025

(54) SYSTEMS AND METHODS FOR PROCESSING BEHAVIORAL ASSESSMENTS

(71) Applicant: cloverleaf.me, inc., Cincinnati, OH (US)

(72) Inventors: Darrin Murriner, Fort Thomas, KY (US); Lane Allison, Del Mar, CA (US); Alex Wilson, Woodstock, VT (US)

(21) Appl. No.: 18/981,901

(22) Filed: Dec. 16, 2024

Related U.S. Application Data
(60) Provisional application No. 63/611,296, filed on Dec. 18, 2023.

(51) Int. Cl. G06Q 10/0631; G06N 20/00

(52) U.S. Cl. CPC G06Q 10/063114; G06Q 10/063118; G06N 20/00

(57) ABSTRACT

A system and method for processing third party behavioral assessments that receives data for a first and second behavioral assessment, the first behavioral assessment assessing a first behavioral characteristic of a first person and the second behavioral assessment assessing a second behavioral characteristic of the first person; utilizes the first and second behavioral characteristics to calculate a behavioral parameter for the first person; compares the behavioral parameter against corresponding behavioral parameters for respective persons for a team; provides a user interface to a user device that is configured to receive a team dynamic selection; receives a hypothetical scenario dataset that describes how the first person would work with the respective persons of the team; determines an impact of including the first person in the team, based on the desired dynamic for the team and the hypothetical scenario dataset; and displays the impact via the user interface.

### CROSS REFERENCE TO RELATED APPLICATIONS

This application claims the benefit of U.S. Provisional Patent Application No. 63/611,296, filed on Dec. 18, 2023, the disclosure of which is hereby incorporated in its entirety.

### TECHNICAL FIELD

Embodiments described herein generally relate to systems and methods for processing behavioral assessments and, more specifically, to compiling and analyzing a plurality of behavioral assessments from a plurality of different sources.

### BACKGROUND

Currently various behavioral assessment services are available that allow users to take a behavioral test and compare their personal results against other tests they have taken. Additionally, the tests are oftentimes administered by employers such that the results may be used to better understand the people that the employer utilizes. As an example, DISC™, Myers-Briggs™, Birkman™, Enneagram™, CliftonStrengths™, Caliper™, Profile XT™, and/or other assessments may be taken by individuals and analyzed by employers. While these behavioral assessments are often beneficial, each behavioral assessment provides different results and employers have no access to that data once the particular behavioral assessment is complete. As such, a need exists in the industry.

### SUMMARY

Embodiments described herein include systems and methods for processing behavioral assessments, including machine learning (ML) systems and methods for analyzing or improving enterprise tactics or behavioral assessments.

One embodiment of a system includes a computing device for training a machine learning model for optimizing one or more enterprise or team outcomes. The computing device can comprise logic that, when executed by the computing device, causes the system to: obtain a dataset of identified enterprise or team metrics, train a ML model using the dataset of identified enterprise/team metrics thereby obtaining a trained ML model, and store the trained ML model.

Another embodiment under the present disclosure is a computer implemented method for training a machine learning model for optimizing one or more enterprise or team outcomes. The method comprises obtaining a dataset of identified enterprise or team metrics and training the ML model using the dataset of identified enterprise/team metrics thereby obtaining a trained ML model. The method further comprises storing the trained ML model. This method can comprise a variety of additional or alternative steps. For example, it can further comprise inference steps, such as obtaining a dataset of optimized enterprise/team tactics or metrics by the trained model by inputting a dataset of enterprise/team tactics/metrics into the trained model, wherein the dataset of enterprise/team tactics/metrics comprises one or more of: one or more personality assessments; one or more personality assessments compared to each other; one or more sales outcomes; one or more profitability metrics; one or more retention metrics; and one or more enterprise/team outcomes related to any of the foregoing.

Another possible embodiment of a method under the present disclosure is a computer implemented method for obtaining optimized team composition. The method includes inputting a dataset of team composition metrics into a trained model, the model being trained using one or more of: one or more personality assessments; one or more personality assessments compared to each other; one or more sales outcomes; one or more profitability metrics; one or more retention metrics; and one or more enterprise/team outcomes related to any of the foregoing. The method further comprises obtaining a dataset of team composition tactics labeled by the trained model. The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for processing behavioral assessments, according to embodiments described herein;

FIG. 2 depicts a user interface for selecting behavioral assessments for processing, according to embodiments described herein;

FIG. 3 depicts a user interface for providing behavioral traits, strengths, and culture in a behavioral assessment, according to embodiments described herein;

FIG. 4 depicts a user interface for processing behavioral assessments for a team, according to embodiments described herein;

FIG. 5 depicts a user interface for providing insights of a personal feed, according to embodiments described herein;

FIG. 6 depicts a user interface for providing a relationship map for a team, according to embodiments described herein;

FIG. 7 depicts a user interface for expanding on the relationship map, according to embodiments described herein;

FIG. 8 depicts a user interface for providing individual insights, according to embodiments described herein;

FIG. 9 depicts a user interface for graphically depicting enterprise behavioral data regarding team members, according to embodiments described herein;

FIG. 10 depicts a user interface for creating team roles, according to embodiments described herein;

FIG. 11 depicts a user interface for creating a team template, according to embodiments described herein;

FIG. 12 depicts a user interface for setting target team dynamics, according to embodiments described herein;

FIG. 13 depicts a user interface for determining team members according to a target team dynamic, according to embodiments described herein;

FIG. 14 depicts a user interface for providing an anonymous public assessment data for a team, according to embodiments described herein;

FIG. 15 depicts a user interface for providing a user superimposed into team data, according to embodiments described herein;

FIG. 16 depicts a user interface for providing behavioral data associated with meeting participants, according to embodiments described herein;

FIG. 17 depicts a user interface for providing communication details associated with a recipient of an electronic communication, according to embodiments described herein;

FIG. 18 depicts a user interface for providing communication details associated with a recipient of an electronic communication, according to embodiments described herein;

FIG. 19 depicts a user interface for providing recommendations for team roles, according to embodiments described herein;

FIG. 20 depicts a user interface for providing team skills, according to embodiments described herein;

FIG. 21 depicts a user interface for providing skills and competencies, according to embodiments described herein;

FIG. 22 depicts a user interface for providing a graphical representation of skills and competencies, according to embodiments described herein;

FIG. 23 depicts a user interface for providing a development plan, according to embodiments described herein;

FIG. 24 depicts a user interface for identifying candidate fit, according to embodiments described herein;

FIG. 25 depicts a user interface for providing job details associated with a candidate, according to embodiments described herein;

FIG. 26 depicts a user interface for viewing a candidate assessment details, according to embodiments described herein;

FIG. 27 depicts a user interface for providing a list of possible applicants, according to embodiments described herein;

FIG. 28 depicts a user interface for providing a dashboard of personalities for a possible new team member, according to embodiments described herein;

FIG. 29 depicts a user interface for providing a selected candidate, according to embodiments described herein;

FIG. 30 depicts a user interface for identifying a team that would be a good fit for an existing employee, according to embodiments described herein;

FIG. 31 depicts a flowchart for aggregating assessment data, according to embodiments described herein;

FIG. 32 depicts a flowchart for an enterprise to construct an optimal team, according to embodiments described herein;

FIG. 33 depicts a flowchart for processing behavioral assessments, according to embodiments described herein;

FIG. 34 depicts a remote computing device for processing behavioral assessments, according to embodiments described herein;

FIG. 35 depicts a ML/AI lifecycle;

FIG. 36 illustrates a sample neural network;

FIG. 37 depicts a flow chart of a method embodiment under the present disclosure; and

FIG. 38 depicts a flow chart of a method embodiment under the present disclosure.

### DETAILED DESCRIPTION

Embodiments disclosed herein include systems and methods for processing behavioral assessments. Some embodiments may be configured to receive results from a plurality of behavioral assessments for a plurality of different people. The people may be organized into teams (such as a first team and/or a second team and such as by a user who is the employer or potential employer of those people), so that the user can view a compiled assessment of the plurality of behavioral assessments, as well as view the team and the dynamics among the team members.

These embodiments may be configured to not only compile and display information from the behavioral and skill-based assessments, but to calculate and predict interactions among team members; recommend new teammates to a team based on these calculations and predictions; provide an interface for a user to define characteristics of a desired team; etc. Some embodiments may use assessments (including behavioral or psychometric assessments) to provide an evaluation of the level of skill of specific components of behavior including motivation, communication style, work style, conflict triggers, personal development approach, and leadership.

As such, embodiments may be configured to bring together multiple personality and strengths assessments into one view and into one database to draw insights on people in an organization. Embodiments also cross map these assessments to map results from one to likely results from the others. The systems and methods for processing behavioral assessments incorporating the same will be described in more detail, below.

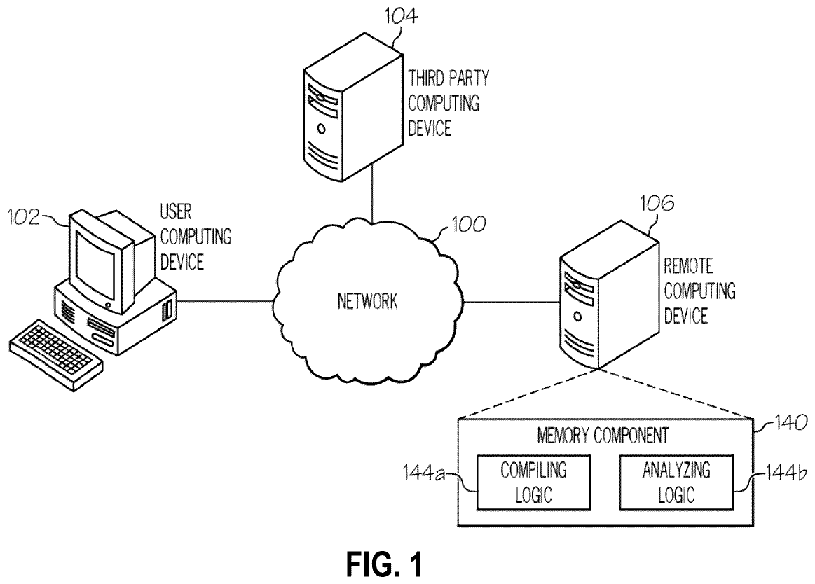

Referring now to the drawings, FIG. 1 depicts a computing environment for processing behavioral assessments, according to embodiments described herein. As illustrated, a network 100 is coupled to a user computing device(s) 102, a third party computing device(s) 104, and a remote computing device(s) 106. The network 100 may include any wide area network, local network, peer-to-peer network, etc. As an example, the network 100 may include the internet, a public switch telephone network, a cellular network (such as 3G, 4G, LTE, etc.), and/or the like. Similarly, the network 100 may include local networks, such as a local area network, Bluetooth network, Zigbee, near field communication, etc.

Coupled to the network 100 is the user computing device(s) 102. The user computing device 102 may be configured as any computing device for a user to take one or more behavioral assessments such as via the third party computing device 104. Additionally, the user computing device 102 may be utilized to communicate with the remote computing device 106 for providing the user interfaces and functionality described in more detail below. While depicted in FIG. 1 as a desktop device, the user computing device 102 is not so limited. Some embodiments may be configured to provide the analysis and data described herein as a mobile device, laptop, tablet, server, etc.

The third party computing device(s) 104 may be configured as a server, personal computer, laptop, mobile device, etc. and may be configured to provide one or more services (such as DISC™, Myers-Briggs™, Birkman™, Enneagram™, Strengths™, Caliper™, Profile XT™, etc.) for providing a behavioral assessment to a user on the user computing device 102. It should be noted that, as each behavioral assessment provider may be independently operated, the third party computing device 104 may include a plurality of separate computing devices that each provide the respective behavioral assessment.

The remote computing device(s) 106 may be configured to communicate with the user computing device 102 and/or the third party computing device 104 via the network 100. As such, the remote computing device 106 may be configured as a server, personal computer, smart phone, laptop, notebook, etc. The remote computing device 106 may include a memory component 140, which stores compiling logic 144a and analyzing logic 144b. As described in more detail below, when executed by the remote computing device 106, the compiling logic 144a may be configured cause the remote computing device 106 to acquire and combine the results from a plurality of different behavioral assessments for a plurality of different individuals (who may or may not be users). The analyzing logic 144b may be configured to cause the remote computing device 106 to analyze the results of the compiled data for making determinations regarding a person and/or selected groups of people.

It will be understood that while the compiling logic 144a and the analyzing logic 144b are depicted as residing in the memory component 140 of the remote computing device 106, this is merely an example. Some embodiments may be configured with logic for performing the described functionality in the user computing device 102. Similarly, some embodiments may be configured to utilize another computing device not depicted in FIG. 1 for providing at least a portion of the described functionality.

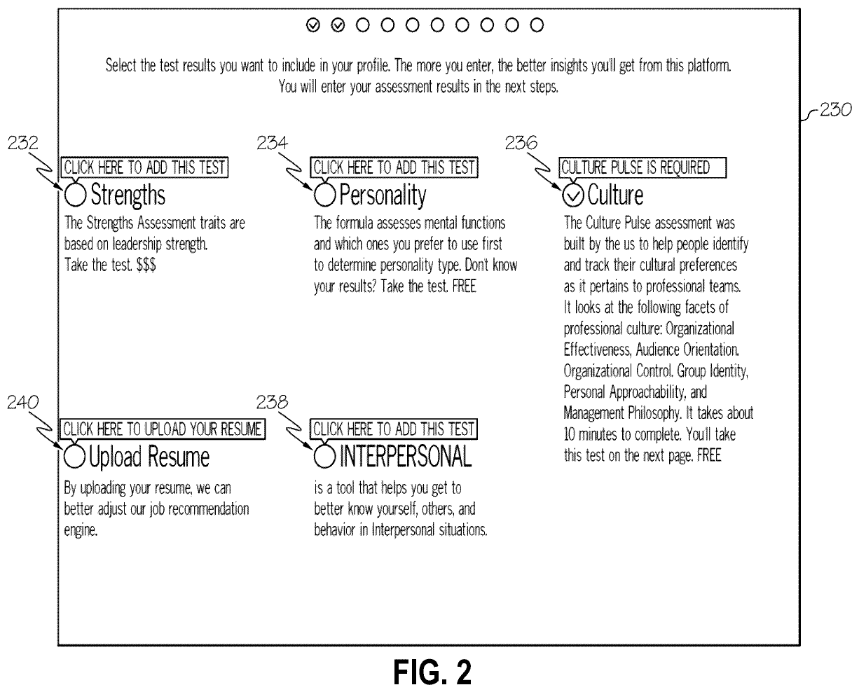

FIG. 2 depicts a user interface 230 for selecting behavioral assessments for processing, according to embodiments described herein. As illustrated, the user interface 230 includes a strengths option 232, a personality option 234, a culture option 236, an interpersonal option 238, and a resume option 240. In response to selection of the strengths option 232, the user may be taken to a website or other portal to take a strengths behavioral assessment. If the person has already taken the strengths assessment, the user may upload the results of that assessment. In response to a user selection of the personality option 234, the user may upload and/or be taken to a portal to take the personality behavioral assessment. In response to selection of the culture option 236, a culture behavioral assessment may be taken and/or uploaded. In response to selection of the interpersonal option 238, an interpersonal behavioral assessment may be taken and/or uploaded. In response to selection of the resume option 240, the user may be provided with options for uploading his/her resume.

As an example, a person may participate in a DISC assessment for interpersonal classifications and may enter and/or upload the results of that assessment into the remote computing device 106. Similarly, Strengths™, MATH, Enneagram™, Myers-Briggs™, Birkman™, and/or other behavioral assessments may be uploaded and/or linked.

In response to uploading the person's resume via the user interface 230, data related to the resume may be stored. Additionally, some embodiments may be utilized to analyze the resume for behavioral queues and/or for providing suggestions related to improving the resume itself. As an example, these embodiments may scan the data in the resume and may determine education background, career background, hobbies, etc., which may be utilized to determine behavioral information. Metadata, such as font, alignment, typographical errors, etc. may also be identified and utilized to further assess the behavioral characteristics of the person. As discussed in more detail below, this analysis may be compiled and combined with other data to provide a behavioral assessment and/or determine a behavioral characteristic of the person.

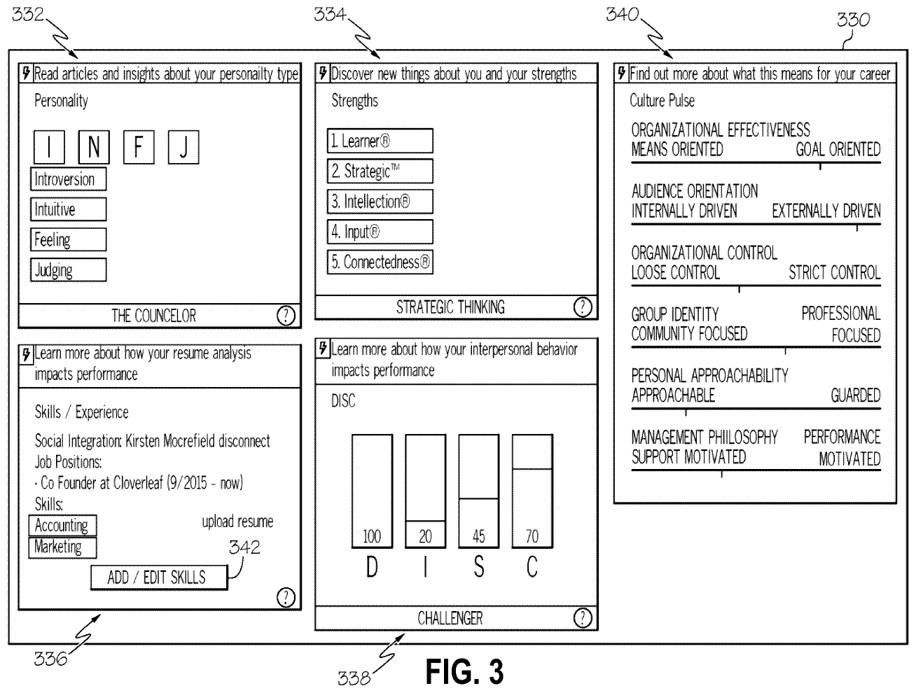

FIG. 3 depicts a user interface 330 for providing behavioral traits, strengths, and culture in a behavioral assessment, according to embodiments described herein. As discussed above, embodiments described herein may receive data related to one or more behavioral assessment that defines a behavioral characteristic. The behavioral characteristics may include strategic thinking, behavior-based performance, how the behavioral characteristic affects a career, etc. Specifically, the user interface 330 includes a personality section 332, a strengths section 334, a resume analysis section 336, an interpersonal section 338, and a culture pulse section 340.

The personality section 332 may provide information regarding various characteristics of the person's personality, such as via the personality option 234 from FIG. 2. The strengths section 334 may provide information related to the strengths option 232 from FIG. 2. The interpersonal section 338 may provide information related to the interpersonal option 238 from FIG. 2. The culture pulse section 340 may provide information associated with the culture option 236 from FIG. 2. The resume analysis section 336 may provide information related to the analysis from the uploaded resume. Also provided is a skills option 342 for the user to provide more information and/or edit the existing information related to skills of the person.

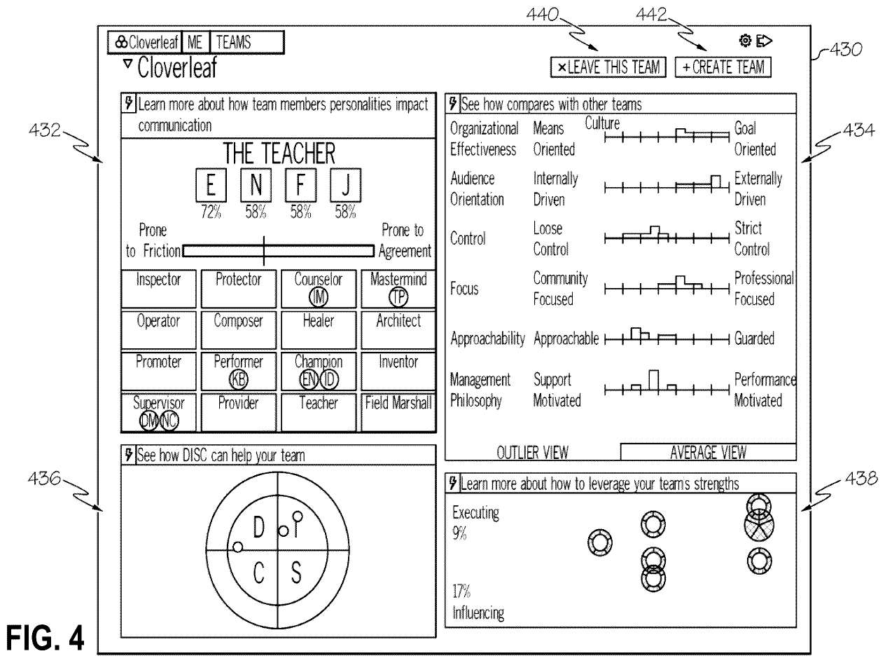

FIG. 4 depicts a user interface 430 for processing behavioral assessments for a team, according to embodiments described herein. As illustrated, the user interface 430 may provide a plurality of people of a common organization, such as a business, sports team, social group, religious group, etc. who may all participate in the platform and submit data associated with behavioral assessment. The user may additionally indicate that a particular person is part of a team. As such, the user interface 430 may provide information regarding one or more people on that team. Specifically, an analysis may be performed that compares a behavioral characteristic of a particular person with a behavioral characteristic of a person on the team.

The user interface 430 may then show a user how a particular person interacts with the team as a whole and/or how the particular person interacts with other members of the team. Accordingly, the user interface 430 includes a personality section 432 that illustrates how the person's personality impacts communication with other team members. Specifically, embodiments described herein may compare personality-based behavioral assessments among the team members to provide this information.

A culture pulse section 434 may show how the person compares with other team members in the culture pulse behavioral assessment. An interpersonal section 436 may show how the person compares with regard to the interpersonal behavioral assessment. The strengths section 438 may provide information related to how the person compared with others team members in the strengths behavioral assessment. Also provided is a leave option 440 and a create team option 442 for leaving a current team and creating a new team, respectively.

It should be understood that, while the person may be compared to a team, some embodiments may be configured to determine a team ranking and/or team score, based on the behavioral assessments of the members of that team. The team ranking may then be compared with other teams to determine which teams may be best for a particular project.

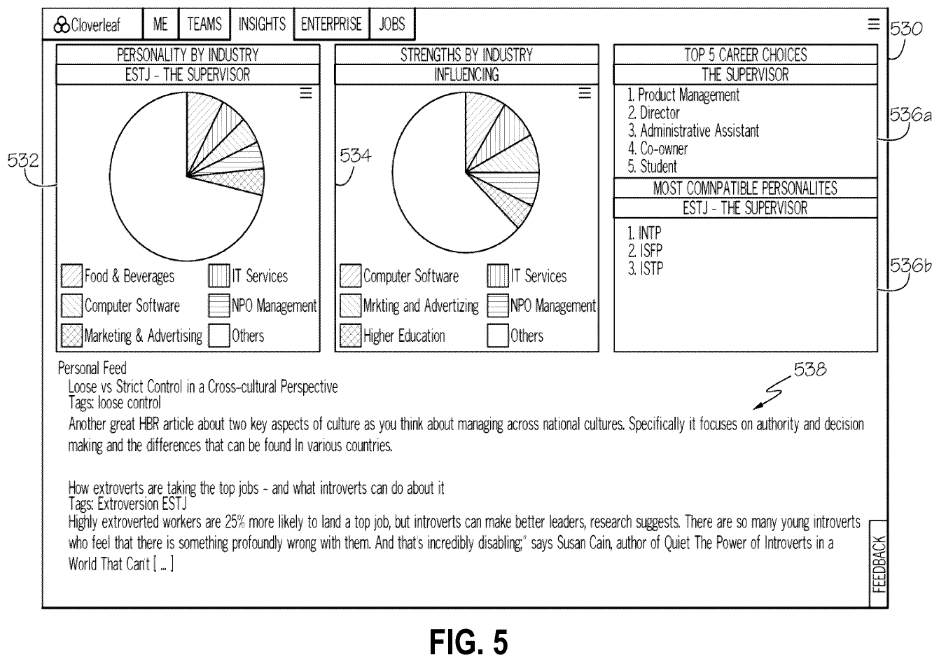

FIG. 5 depicts a user interface 530 for providing insights of a personal feed, according to embodiments described herein. As illustrated, the user interface 530 includes a personality chart section 532, a strengths chart section 534, a career choices section 536a, a compatible personalities section 536b, and a personal feed section 538. Specifically, the personality chart section 532 graphically illustrates the industries that have people with a common personality assessment as the person. The strengths chart section 534 graphically depicts the industries that most often include people with a common strength assessment as the person. The career choices section 536a may provide one or more career choices for the person. The compatible personalities section 536b may provide those personalities that are most likely to be compatible with the person. The personal feed section 538 may provide articles, posts, and other information that is pertinent to the person and/or user.

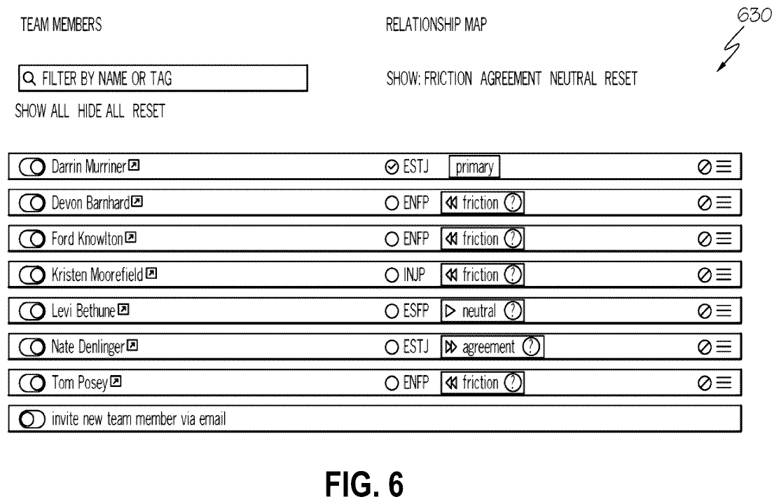

FIG. 6 depicts a user interface 630 for providing a relationship map for a team, according to embodiments described herein. As illustrated, the user interface 630 provides a listing of each of the team members. The relationship map illustrates the likely friction or agreement between that team member and the selected “primary” team member. The user may select the desired “primary” team member and may activate and deactivate any team member from this analysis. The likely friction and/or agreement may be determined based on an analysis of behavioral (personality, proficiency, communication, etc.) categories that were determined from the submitted behavioral assessments.

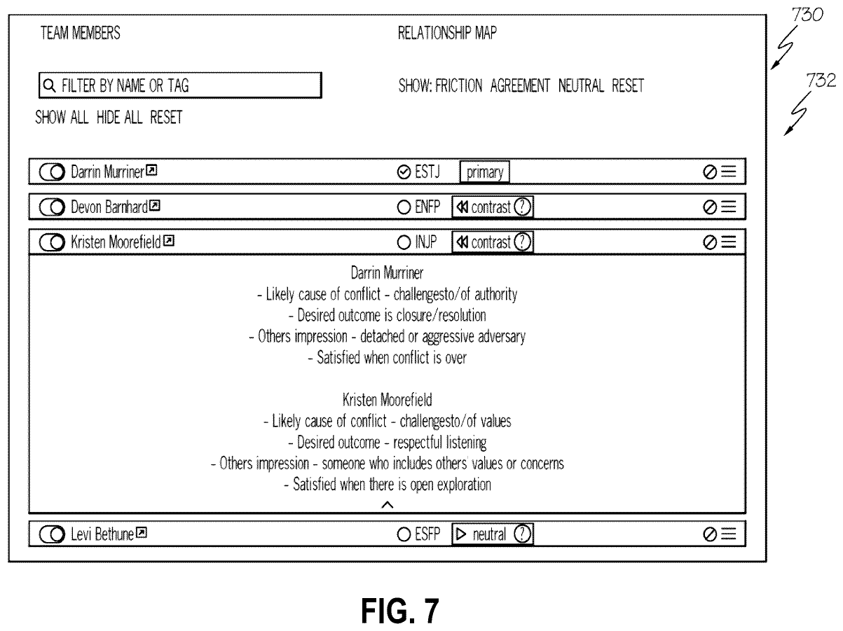

FIG. 7 depicts a user interface 730 for expanding on the relationship map, according to embodiments described herein. Embodiments described herein may be configured to calculate a relationship map that indicates relationships among team members of the first team based on relationship criteria. The relationship criteria may include friction, agreement, neutral, and/or other relationship criteria. As such, the window 732 illustrates reasons that the remote computing device 106 determined that friction, agreement, etc. are likely between two team members. Based on the behavioral assessments and/or behavioral characteristics derived therefrom, a determination may be made regarding whether any two people on a team are likely to find conflict, agreement, or be neutral. The comparison may be performed from an overall behavioral characteristic from a compilation of two or more behavioral assessments and/or may be derived from a single behavioral assessment.

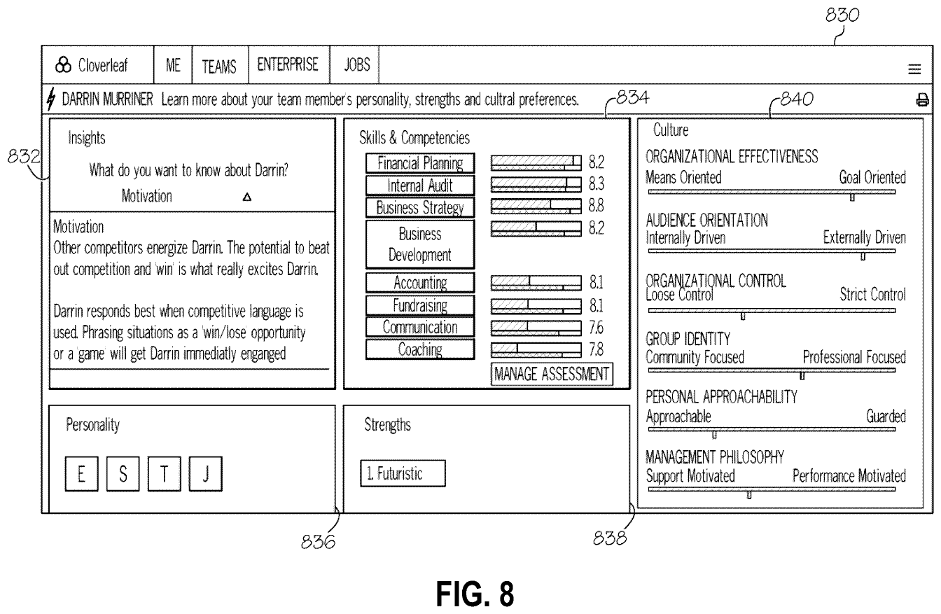

FIG. 8 depicts a user interface 830 for providing individual insights, according to embodiments described herein. Specifically, the user interface 830 allows the user to drill down further on underlying behaviors and how to tailor that person's approach to the individual that is provided in the user interface 830. Specifically, while the user interfaces 330 (FIG. 3), 430 (FIG. 4), and 530 (FIG. 5) are directed to a person reviewing their own information, the user interface 830 may be provided for a user to review another person's information. As such, the user interface 830 includes an insights section 832, a skills section 834, a personality section 836, a strengths section 838, and a culture section 840. While in some embodiments, this may be the same information provided in the user interface 330 (FIG. 3), some embodiments may be configured to filter some of this information, depending on a predetermined access level of the user viewing the information. As an example, a superior may be granted access to see all of a person's information while a peer or someone reporting to the person may only be able to see a portion of the information.

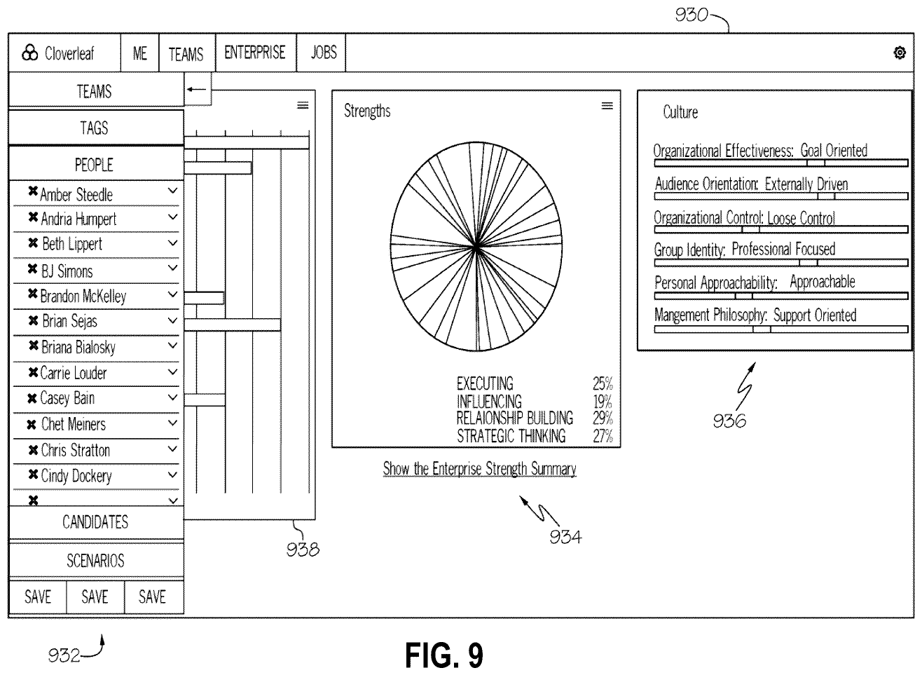

FIG. 9 depicts a user interface 930 for graphically depicting enterprise behavioral data regarding team members, according to embodiments described herein. As illustrated, a user may create teams, tags, and/or roles for enterprise members. As an example, a user may create the tags lava,” “UI/UX,” etc. and may assign those tags to the enterprise members that have experience with Java™ and user interface/user experience, respectively. The user may additionally assign enterprise members to teams to determine which teams fulfill the objectives set by the user. These scenarios may then be saved for later retrieval. It should be noted that in some embodiments, the system may provide reporting to enterprise users on how their employees are using the platform and the value they are getting from using the system.

Accordingly, the user interface 930 may include a people section 932, a strengths section 934, a culture section 936, and a skills section 938. In the people section 932, the user may define teams, tags, and/or people that are on the selected team. Candidate team members may be added to determine how the behavioral characteristics of the candidate affect the team and/or team members. A user may also be provided with an option to create and/or implement scenarios to determine under which situations the behavioral characteristics of team members (or candidate team members) will affect the team.

In the strengths section 934, the selected information from the people section 932 may be graphically depicted to show the strengths of the team overall and/or for particular scenarios. In the culture section 936, team culture information may be provided overall and/or for particular scenarios. In the skills section 938, skills of the people and/or team may be provided.

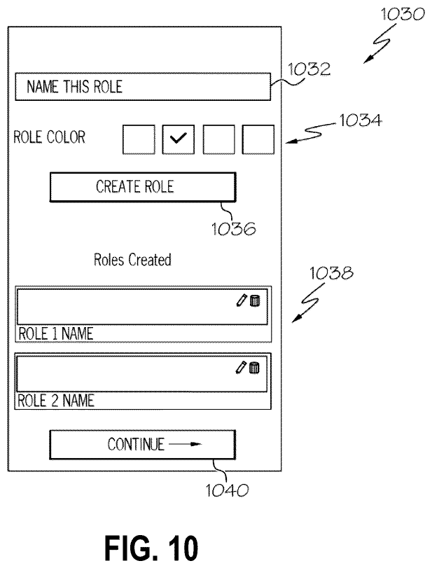

FIG. 10 depicts a user interface 1030 for creating team roles, according to embodiments described herein. As illustrated, a user may create team roles for different team members. As illustrated, the user interface 1030 may include a name field 1032, a color field 1034, a create option 1036, a roles section 1038, and a continue option 1040. Specifically, a user may create a new role by populating the name field 1032, selecting a color for the role in the color field 1034, and selecting the create option 1036. In the roles section 1038, existing roles may be provided. Once the user has finished, the user may select the continue option 1040.

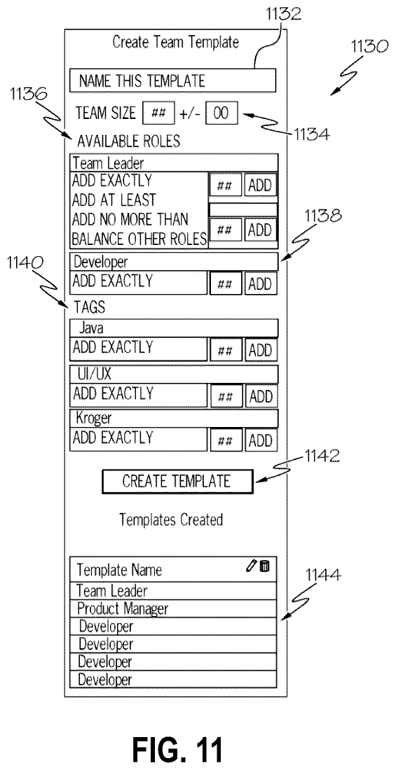

FIG. 11 depicts a user interface 1130 for creating a team template, according to embodiments described herein. As illustrated, the user may create a team template, which may include a team size, roles (such as created in the user interface 1030 from FIG. 10), and tags that are desired for team members. As illustrated, the user interface 1130 may include a name field 1132, a team size option 1134, a team leader option 1136, a developer option 1138, a tags option 1140, and a create template option 1142. Created templates may be provided in the templates section 1144. To create a new template, the user may populate the name field 1132, populate the team size option 1134, select a team leader with the team leader option 1136, select a developer with the developer option 1138, select tags with the tags option 1140, and select the create template option 1142.

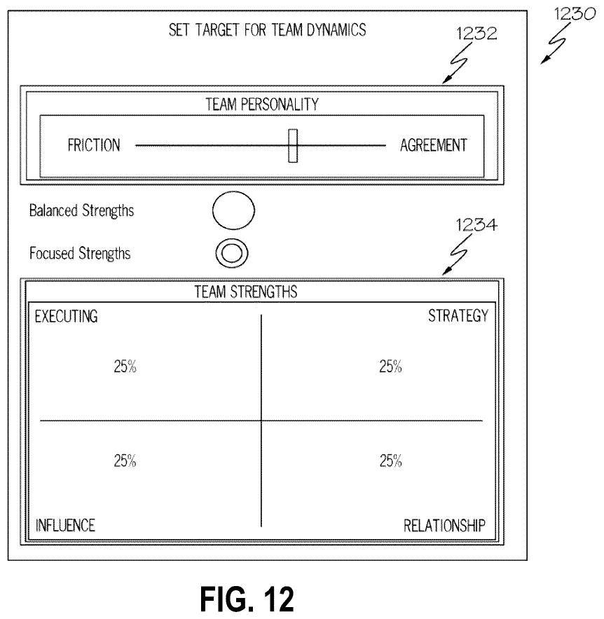

FIG. 12 depicts a user interface 1230 for setting target team dynamics, according to embodiments described herein. Specifically, the user may select the desired behavioral characteristics for a team, such as executing, influence, strategy, and relationship. As illustrated, the user interface 1230 may include a team personality section 1232 for the user to determine a level of friction and/or agreement with the team. Team strengths may be defined in team strengths section 1234 by adjusting the vertical and horizontal lines (thereby reducing the area of any given section) and/or by dragging and dropping balanced strengths and focused strengths into the team strengths section 1234.

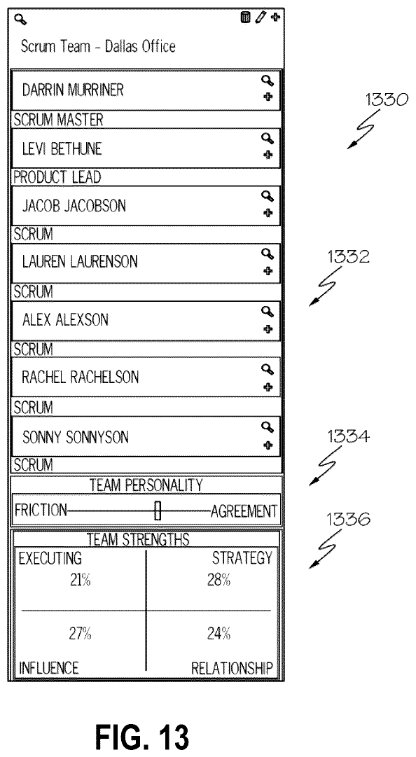

FIG. 13 depicts a user interface 1330 for determining team members according to a target team dynamic, according to embodiments described herein. From the desired dynamics and the available enterprise members, the remote computing device 106 may select the desired team. Specifically, embodiments described herein may compile the behavioral characteristics as calculated from the plurality of different behavioral assessments and receive the team dynamics defined in the user interface 1230 (FIG. 12). With this information, these embodiments may determine a team from a pool of candidate people that will demonstrate the desired team dynamics. As such, the user interface 1330 may provide a listing of those selected team members in the members section 1332, a team personality option 1334 to adjust the desired team personality, and a team strengths option 1336 to adjust the desired team strengths.

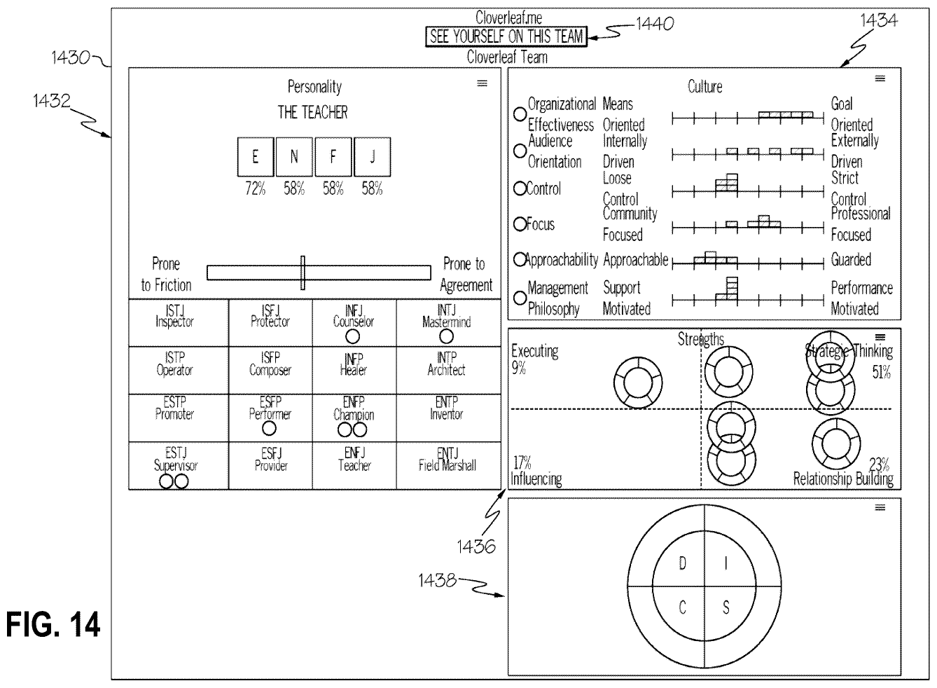

FIG. 14 depicts a user interface 1430 for providing an anonymous public assessment data for a team, according to embodiments described herein. As illustrated, a first user may be a manager who is looking for a new team member. Thus, the first user may create the user interface 1430 with the existing team members, which includes a personality section 1432, a culture section 1434, a strengths section 1436, and an interpersonal section 1438. This dashboard may be stripped of identifying characteristics of individual team members, such that the user interface 1430 may be published to a second user. Also included is an insert me option 1440 for the second user. In response to selection of the insert me option 1440, the remote computing device 106 may insert the second user's behavioral data into the user interface 1430 for determining how the second user fits in the team.

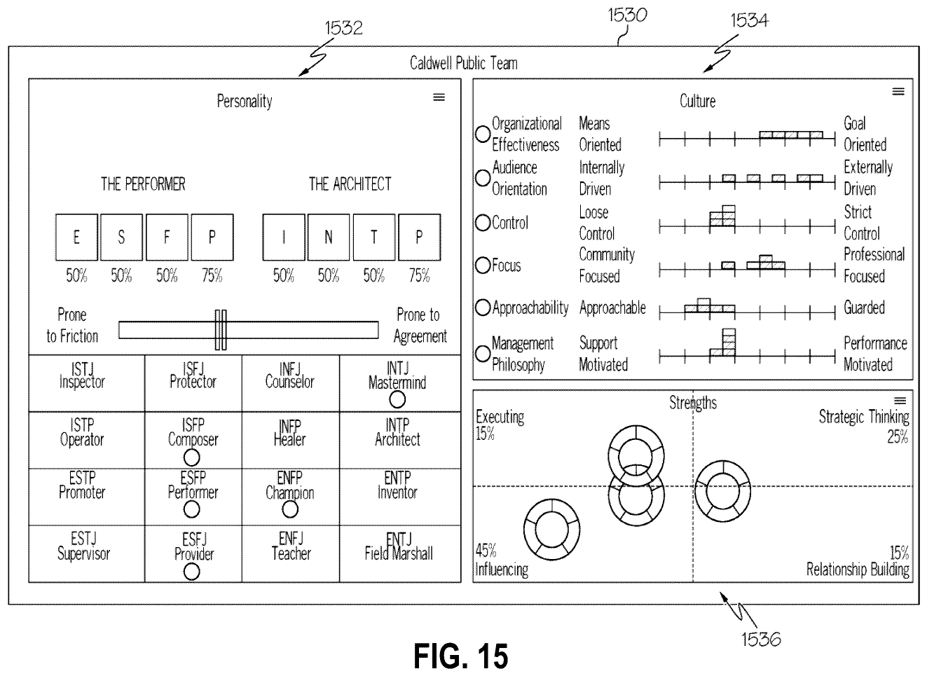

FIG. 15 depicts a user interface 1530 for providing a user superimposed into team data, according to embodiments described herein. In response to selection of the insert me option 1440 from FIG. 14, the remote computing device 106 superimposes a user's behavioral characteristics onto the user interface 1430 from FIG. 14 and presents the interface as user interface 1530. As such, the user interface 1530 includes a personality section 1532, a culture section 1534, a strengths section 1536, and/or other desired behavioral sections.

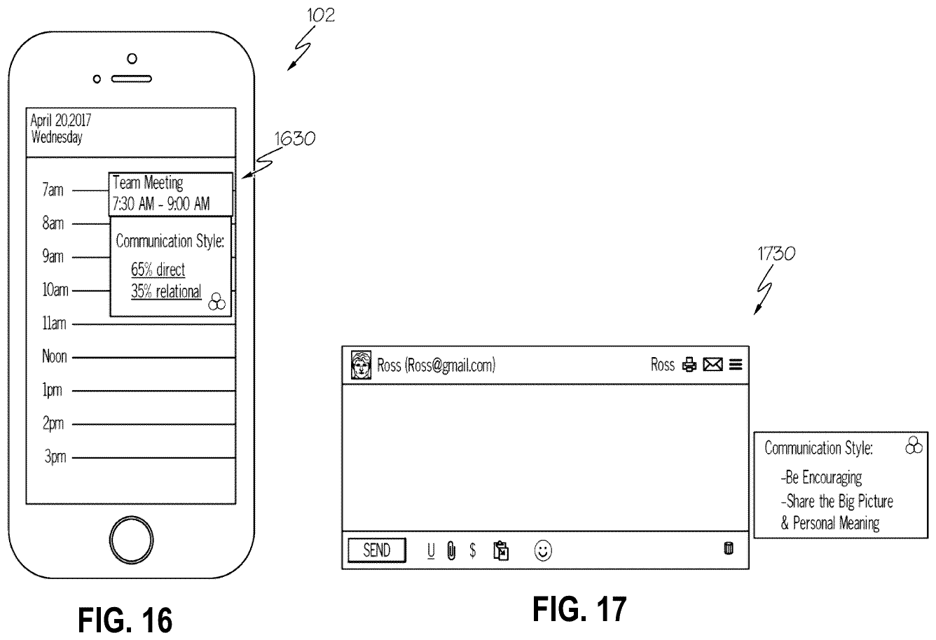

FIG. 16 depicts a user interface 1630 for providing behavioral data associated with meeting participants, according to embodiments described herein. In response to setting a meeting, receiving a communication, etc. the user computing device 102 may provide a behavioral assessment of the other party to the communication. The behavioral assessment may be context dependent, meaning that if it is determined that the communication relates to job opening, the user may receive performance and/or personality information. If it is determined that the communication relates to a social event, different information may be provided. Some embodiments may be static in that the same information is provided, regardless of context.

FIG. 17 depicts a user interface 1730 for providing communication details associated with a recipient of an electronic communication, according to embodiments described herein. In addition to the information about the other party to the conversation, the remote computing device 106 (and/or user computing device 102) may provide at least one actionable insight on the other person, such as motivation, resolving conflict, personal development, leadership development, persuasion, and/or the like, based on their behavioral analysis.

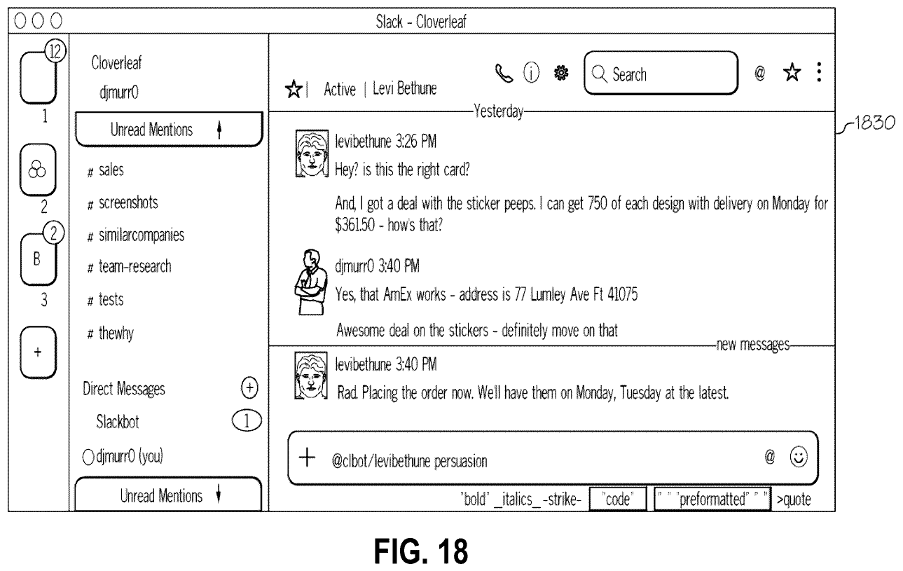

FIG. 18 depicts a user interface 1830 for providing communication details associated with a recipient of an electronic communication, according to embodiments described herein. The electronic communication may be made through commands entered in team messaging apps such as Slack or Microsoft Teams. In addition to the information about the other party to the conversation, the remote computing device 106 may provide recommendations on how to communicate with that other party, based on their behavioral analysis including factors such as persuasion, motivations or work style.

It should be understood that while some embodiments may provide an abbreviated version of the data provided in previous user interfaces in the electronic communication and/or calendar, this is merely an example. Some embodiments may provide options to see the full dashboard and/or provide the full dashboard automatically.

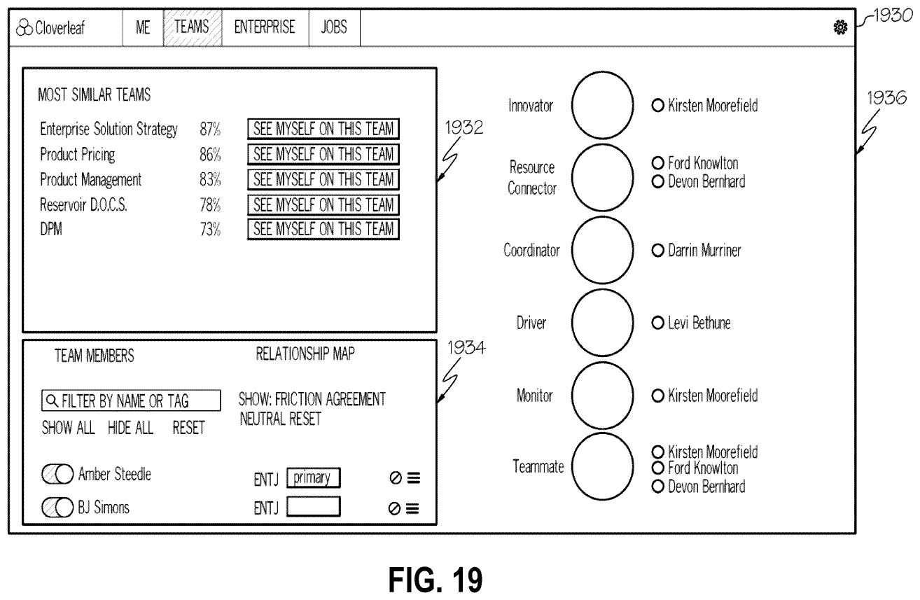

FIG. 19 depicts a user interface 1930 for providing recommendations for team roles, according to embodiments described herein. As illustrated, the user interface 1930 may include a most similar teams window 1932, a relationship map 1934, and a recommendation window 1936, which provides recommendations for various roles. These team role recommendations are formed by cross mapping behavioral data provided by the psychometric assessments and skill data provided by each user in context to the other users on the team. These recommendations may be refined over time using machine learning to determine which roles are best for the users depending on how other team users have responded to these recommendations and based on the unique mix of people on each team.

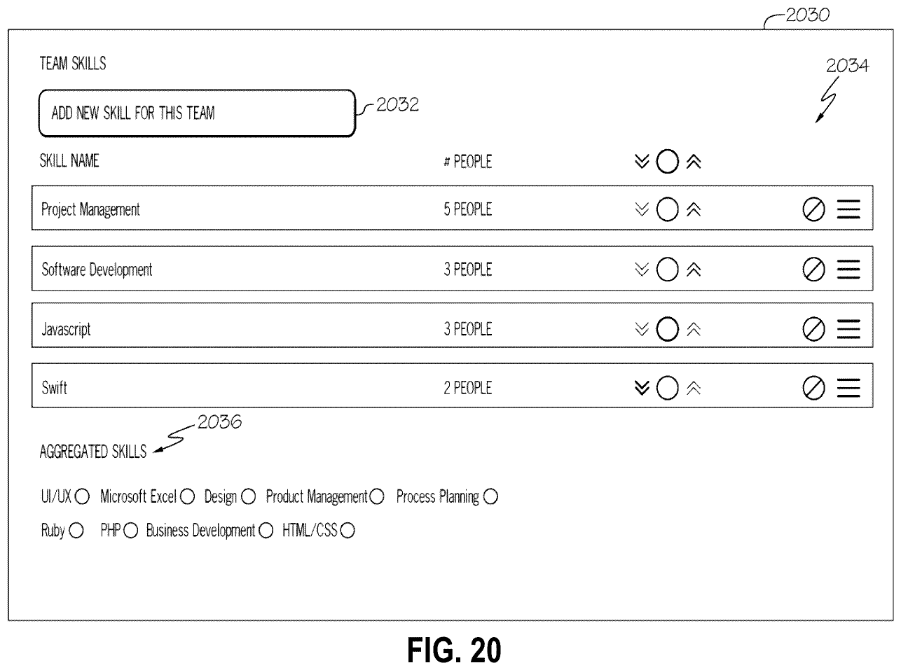

FIG. 20 depicts a user interface 2030 for providing team skills, according to embodiments described herein. As illustrated, an add option 2032 may be provided for adding a new skill for the team. The skills may be added as being important for a particular team and may be ranked in order of importance. Thus, when recommending people to a team, these skill criteria may be utilized in making that recommendation. It should be noted that individual skill ratings may be provided aggregating these skills at the team level so the team leader can identify the level of capabilities around these skills and/or competencies to better refine the selection criteria for the fit of new users to the team. Accordingly, a skill section 2034 may provide the created skills with options for deleting and reordering the listed skills. An aggregated skills section 2036 may also be provided for adding commonly used skills to the team.

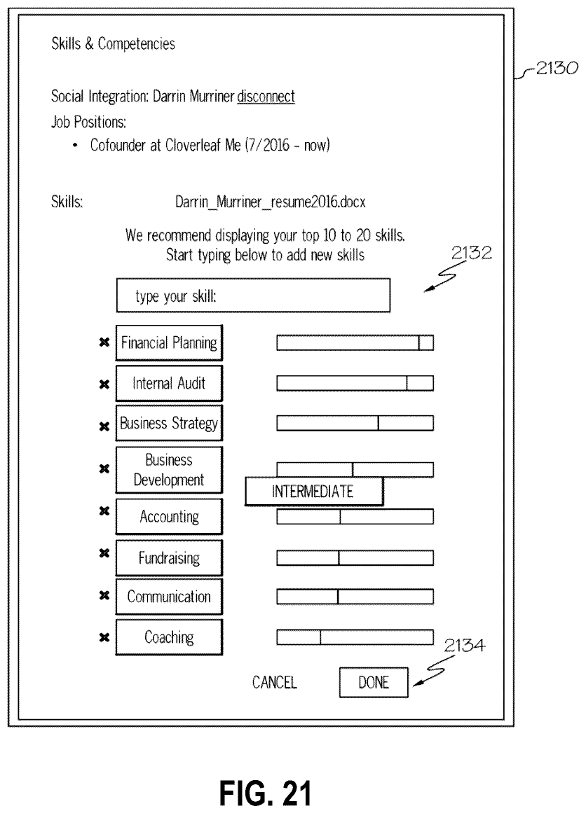

FIG. 21 depicts a user interface 2130 for providing skills and competencies, according to embodiments described herein. As illustrated, the user interface 2130 includes a skill section 2132 for a user to add one or more skills to a profile and rate those skills. Once the skill section 2132 is complete, the user may select a done option 2134. As such, embodiments described herein provide a mechanism for users to identify their top skills and competencies and to provide a rating on those skills/competencies from beginner to expert status. Managers and other team members may also be provided with an option to rate each of these skills of the user, providing a 360 degree view of these capabilities. In some embodiments, this data that may also be aggregated on the team dashboard and used for finding team fit.

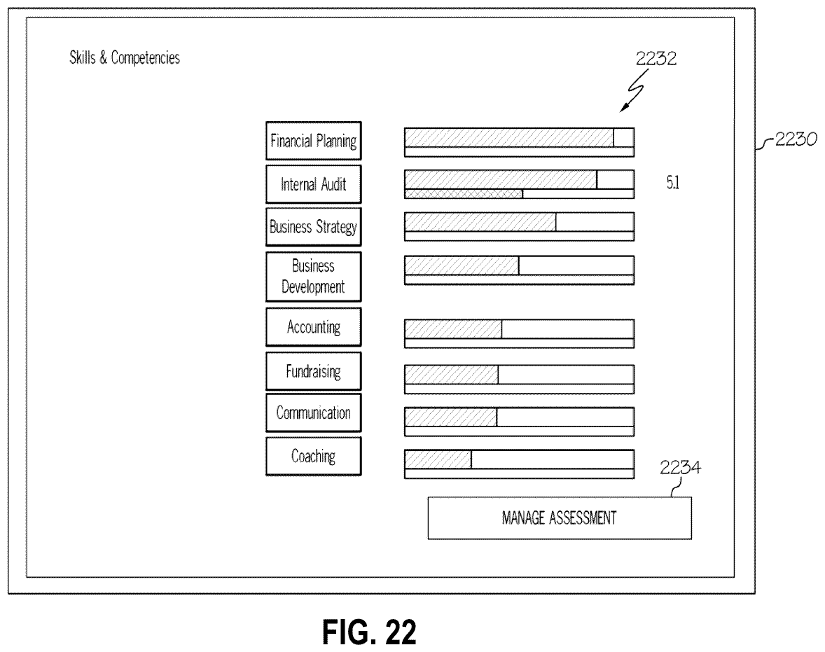

FIG. 22 depicts a user interface 2230 for providing a graphical representation of skills and competencies, according to embodiments described herein. As discussed above, while a user may select and rate their own skills, the user interface 2230 may be provided to a manager for managing the user's self-assessment. As such, the user interface 230 includes an assessment section 2232 that provides the user's self-assessment. A manage assessment option 2234 is provided for the manager to provide comments and/or edit that assessment.

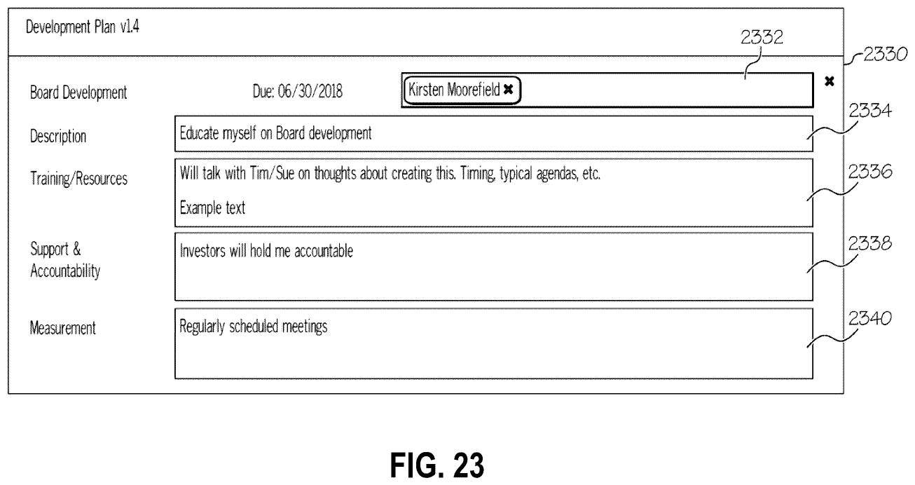

FIG. 23 depicts a user interface 2330 for providing a development plan, according to embodiments described herein. Specifically, embodiments described herein may provide a user with the ability to create goals or development plans throughout in a way that specifically connects team development to individual development. As illustrated, the user interface 2330 may provide a name field 2332, a description field 2334, a training field 2336, a support field 2338 and a measurement field 2340. Depending on the embodiment, a user may populate these fields for themselves. Some embodiments may provide an option for a manager or other third party to populate one or more of the fields for another person.

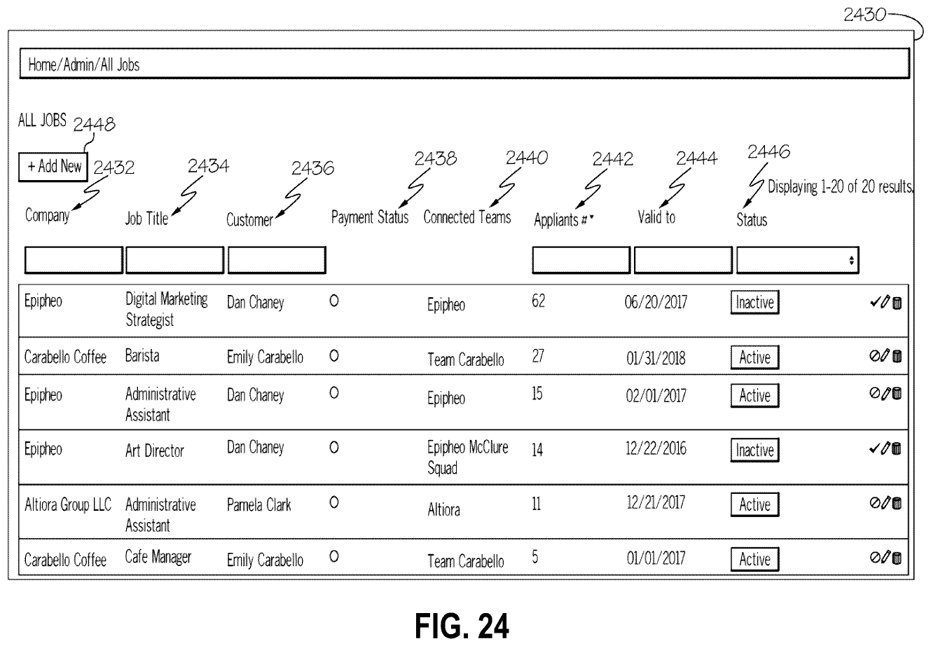

FIG. 24 depicts a user interface 2430 for identifying candidate fit, according to embodiments described herein. Specifically, the user interface 2430 may provide data associated with job openings and applicants to those job openings. As illustrated, the user interface 2430 may provide a company field 2432, a job title field 2434, a customer field 2436, a payment status field 2438, a connected teams field 2440, and applicants field 2442, a validity field 2444, and a status field 2446. Specifically, the company field 2432 may provide the company that has the job opening. The job title may provide the title of the job that has the opening. The customer field 2436 may provide a customer associated with the job opening. The connected teams field 2440 may list the teams with which the job is associated. The applicants field 2442 may indicate the current number of applicants that have applied for the job. The validity field 2444 provides the duration that the job will be advertised. The status field 2446 may provide whether the job opening advertisement is active or inactive.

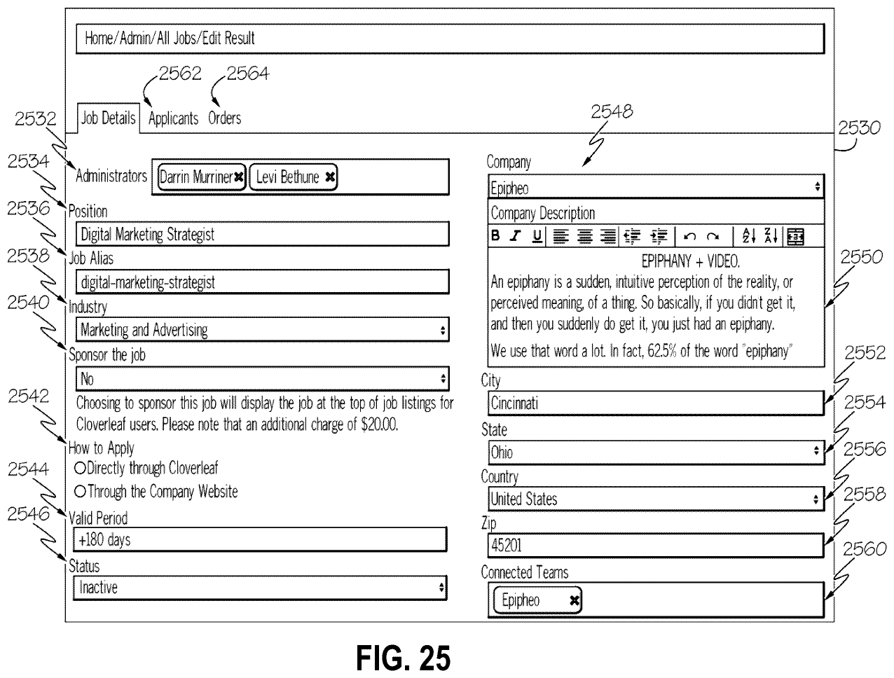

FIG. 25 depicts a user interface 2530 for providing job details associated with a candidate, according to embodiments described herein. As illustrated, a user may create a new job opening and/or edit an existing job opening from the user interface 2430 from FIG. 24. As such, the user interface 2530 may include an administrators field 2532 for viewing and/or editing the administrators to the job opening. A position field 2534 may be populated with the job opening position. A job alias field 2536 may provide a further description of the job opening. An industry field 2538 may receive an industry for the job opening.

A sponsor field 2540 may receive data regarding whether the job opening is sponsored and will thus appear at a more prominent location. An application option 2542 may be provided for a user to indicate how to apply for the job opening. A validity field 2544 may receive information on a time period for the job posting. A status field 2546 may receive an indication of whether the job posting is active or inactive. A company field 2548 may receive a company name of the entity that is providing the job. A company description field 2550 may receive a description of the company offering the job. A city field 2552, a state field 2554, a country field 2556, and a zip field 2558 may receive location information regarding the job. A connected teams field 2560 may receive teams that are connected to the job opening. Also provided are an applicants option 2562 and an orders option 2564, described in more detail below.

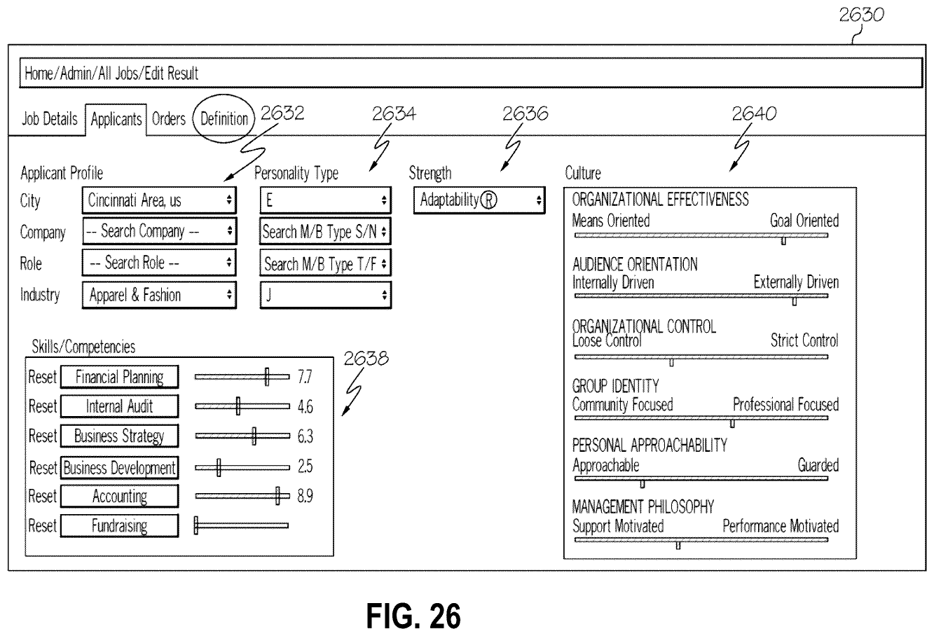

FIG. 26 depicts a user interface 2630 for viewing a candidate assessment details, according to embodiments described herein. In response to selection of the applicants option 2562 from FIG. 25, the user interface 2630 may be provided. As illustrated, the user may define one or more desired behavioral characteristics for job candidate. As illustrated, the user interface 2630 may include a profile section 2632, a personality section 2634, a strength section 2636, a skills section 2638, and a culture section 2640. Accordingly, the user may define a desired applicant profile in the profile section 2632. The user may provide the desired behavioral characteristics in the personality section 2634. The user may select a desired strength characteristic in the strength section 2636. The user may select desired skills and/or competencies in the skills section 2638. The user may define desirable culture characteristics of the job applicant in the culture section 2640. Embodiments may also provide options to add a new person to the comparison and/or delete an existing person from the comparison.

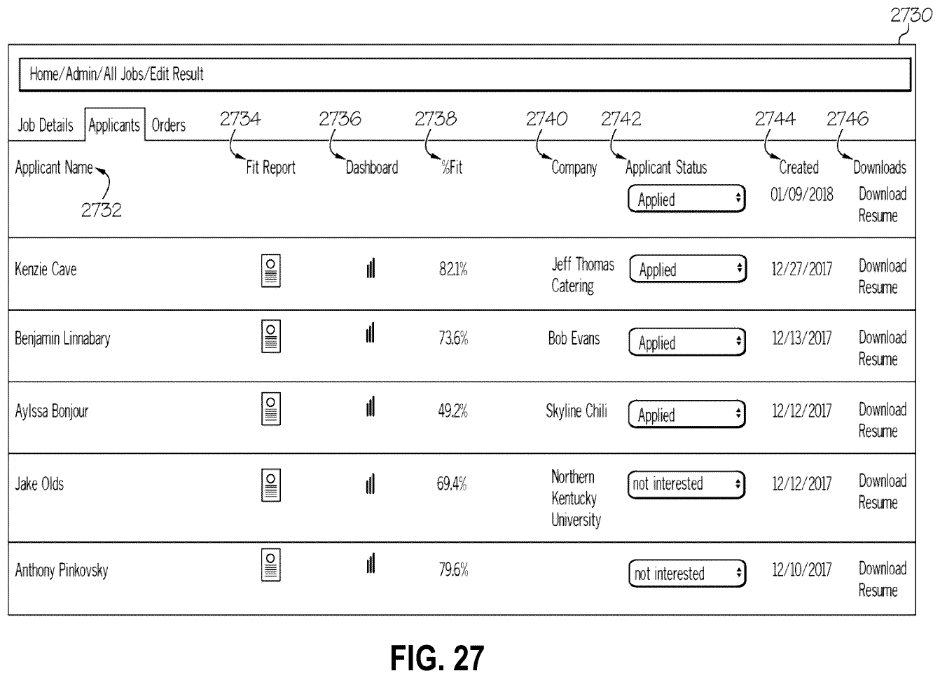

FIG. 27 depicts a user interface 2730 for providing a list of possible applicants, according to embodiments described herein. As illustrated, the user interface 2730 may provide a name field 2732 for listing applicants for a selected job opening. A report field 2734 may provide one or more fit reports for the applicant, based on the applicants behavioral assessments compared with the desirable behavioral characteristics defined in the user interface 2630 (FIG. 26).

A dashboard field 2736 may provide the corresponding behavioral characteristics dashboard of the job applicants. A fit field 2738 may provide a metric of how well the applicant fits for the job. Specifically, embodiments may utilize a proprietary algorithm to weight matches of applicant behavioral characteristics with the desired behavioral characteristics, thereby identifying a ranking of candidates. A company field 2740 may provide the company that is offering the job. A status field 2742 provides a status of the applicant to the job opening. In some embodiments, the user may alter this status, based on changes in the applicant's situation (declined, applied, not interested, etc.). A created field 2744 provides a data when the job posting was created, and a downloads field 2746 may provide options to download a resume and/or other data related to the job applicant.

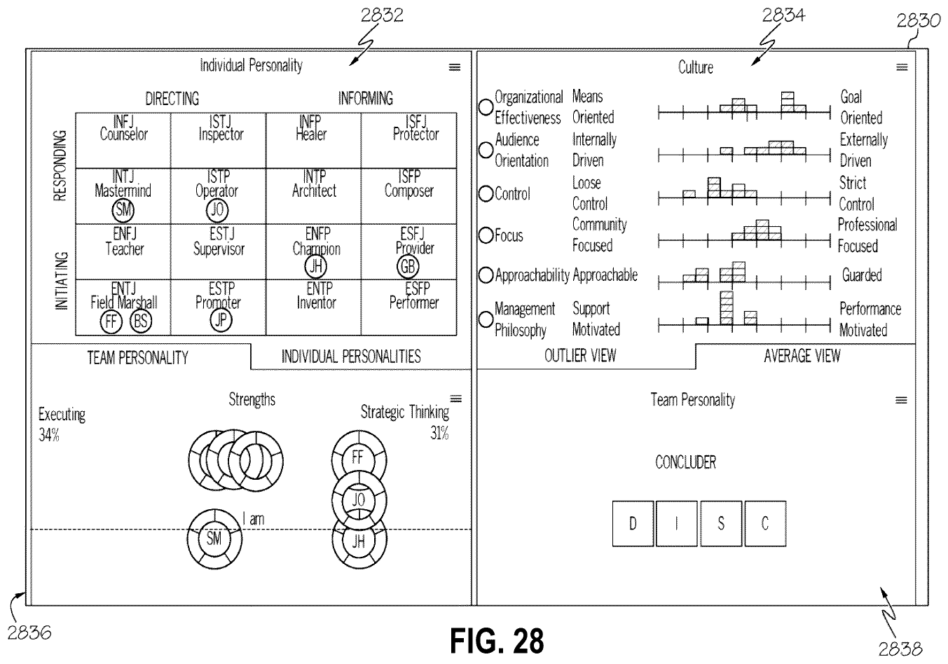

FIG. 28 depicts a user interface 2830 for providing a dashboard of personalities for a possible new team member, according to embodiments described herein. As illustrated, the user interface 2830 provides an individual personality section 2832, a team personality section 2836, a culture section 2834, and an interpersonal section 2838. Specifically, the user interface 2830 may be configured to compare the job applicant's behavioral characteristics with one or more members of a team for which the job posting is related. As such, embodiments may be configured to determine how a job applicant would fit in the job opening and how the job applicant would interact and fit with team members.

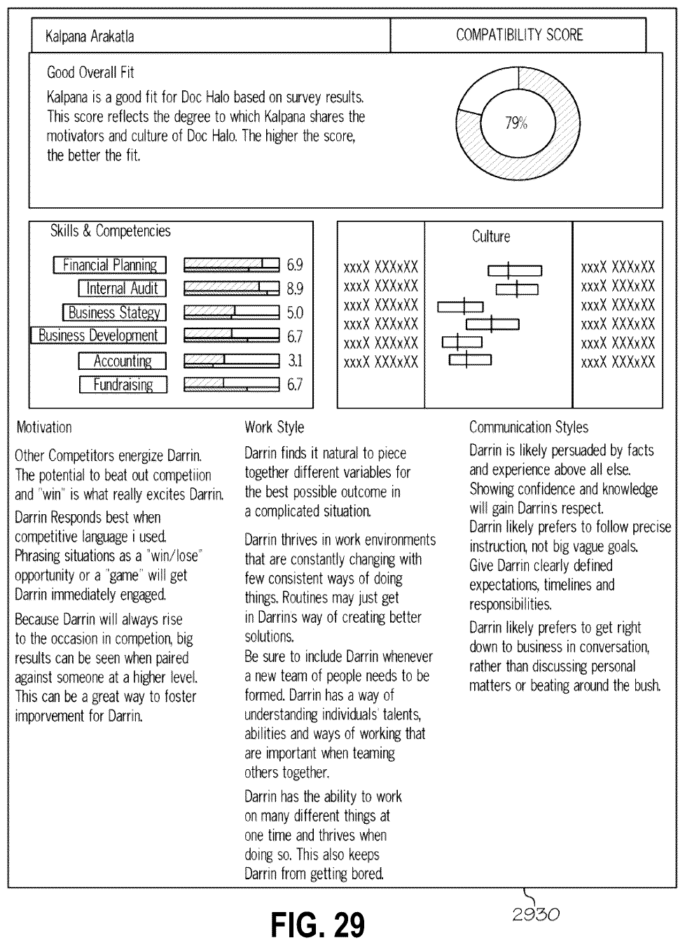

FIG. 29 depicts a user interface 2930 for providing a selected candidate, according to embodiments described herein. As illustrated, the user interface 2930 includes a compatibility score for a job applicant across the plurality of behavioral characteristics that the platform measures. This compatibility score relates to how well the job applicant would fit into the team and provides skills, culture, interpersonal characteristics, strengths, etc. as well as motivation, work style, communication style, etc. which may be used by the employer to determine whether to hire this particular job applicant.

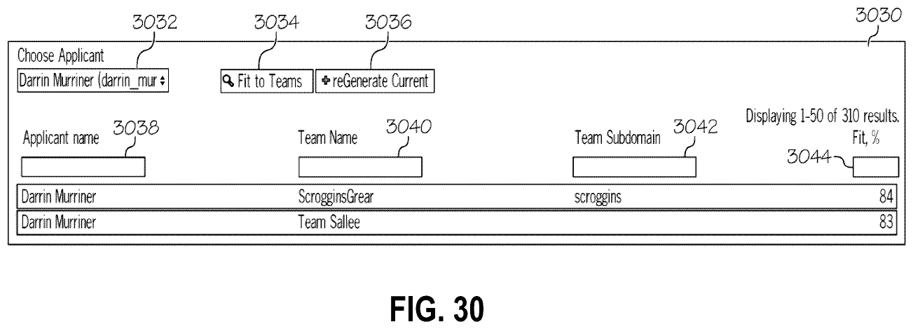

FIG. 30 depicts a user interface 3030 for identifying a team that would be a good fit for an existing employee, according to embodiments described herein. Specifically, embodiments described herein are configured to allow managers and team leaders to identify candidate fit based on various assessments. Leaders may identify (using goal setting) the specific requirements of the job (such as personality types, strengths, skills and proficiencies) and their associated level of skill to determine which candidates are the best fit to the existing team based on the existing combination of team members and the goals of the leader. Using this same data, embodiments may identify teams that would be a good fit for an existing employee or an existing employee that would be a great for an existing team.

As such, the user interface 3030 includes an applicant field 3032, by which a user may designate the applicant. An option 3034 is provided for the user to determine which teams the designated applicant would fit best, based on the behavioral characteristics. A regenerate current option 3036 may also be provided for regenerating assessments for team fit due to changes in team members, etc. Also provided is an applicant search field 3038, a team search field 3040, a subdomain field 3042, and a fit percentage field 3044 by which the user may search from a plurality of listed applicants, teams, and fits. Based on the results of the search, the user may determine which team the applicant best fits.

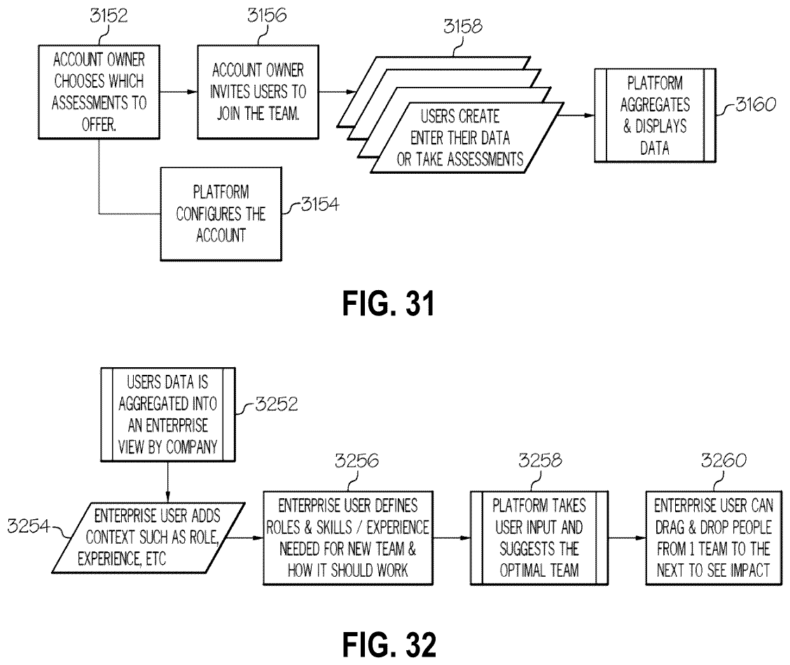

FIG. 31 depicts a flowchart for aggregating assessment data, according to embodiments described herein. As illustrated in block 3152, an account owner may choose which assessment to offer. In block 3154, the remote computing device 106 may configure the account. Additionally, in block 3156, the account owner may invite users to join a team. In block 3158, one or more users may create the account, enter data, and/or participate in the respective behavioral assessments. In block 3160, the remote computing device 106 may aggregate and display the received data.

FIG. 32 depicts a flowchart for an enterprise to construct an optimal team, according to embodiments described herein. As illustrated in block 3252, use data is aggregated into an enterprise view by the enterprise. In block 3254, the enterprise user may add context such as roles, experience, etc. In block 3256, the enterprise user defines roles, skills, experience, etc. required for the team. In block 3258, the remote computing device 106 may receive user input and suggest an optimal team.

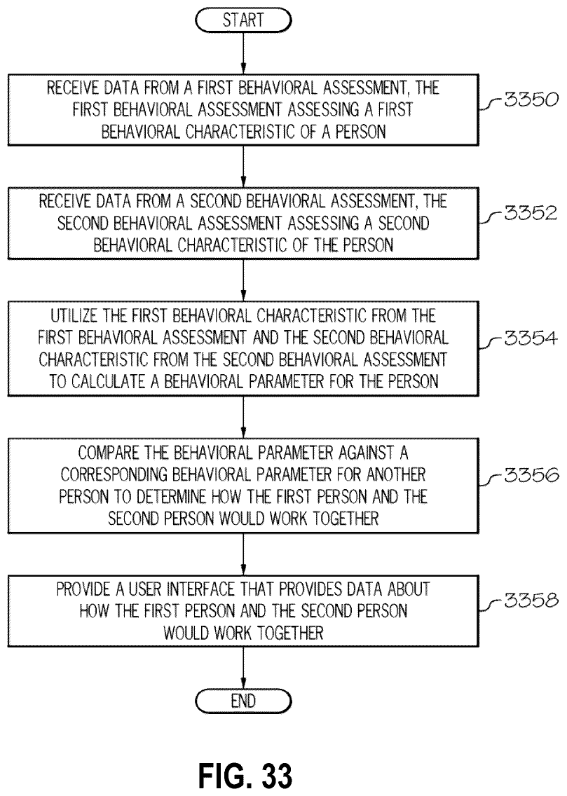

FIG. 33 depicts a flowchart for processing behavioral assessments, according to embodiments described herein. As illustrated in block 3350, data may be received from a first behavioral assessment, the first behavioral assessment assessing a first behavioral characteristic of a person. In block 3352, data may be received from a second behavioral assessment, the second behavioral assessment assessing a second behavioral characteristic of the person. In block 3354, the first behavioral characteristic from the first behavioral assessment and the second behavioral characteristic from the second behavioral assessment may be utilized to calculate a behavioral parameter for the person. In block 3356, the behavioral parameter may be compared against a corresponding behavioral parameter for another person to determine how the first person and the second person would work together. In block 3358, a user interface may be provided that provides data about how the first person and the second person would work together.

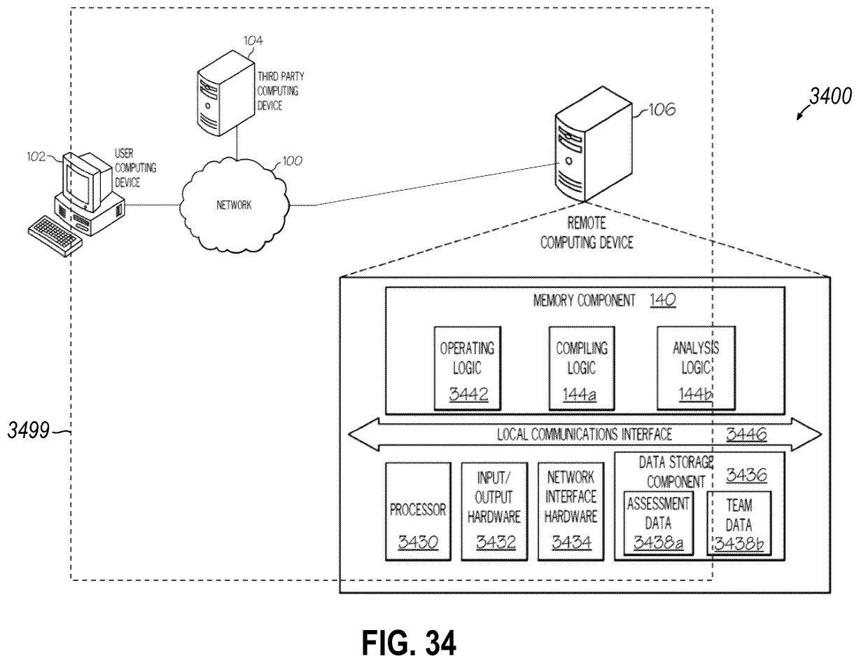

FIG. 34 depicts a behavioral assessment system 3400 comprising remote computing device(s) 106 for processing behavioral assessments, storing artificial intelligence (AI) or machine learning (ML) models, performing ML-based analyses and methods and performing other techniques and/or methods according to embodiments described herein. User computing device(s) 102 and third party computing device(s) 104 are also shown. Certain functionality and types of components are described with respect to remote computing device 106, but are also applicable to third party computing device(s) 104 and user computing device(s) 102 in various embodiments. Remote computing device 106 can comprise any of, or multiple instances and/or combinations of e.g., server(s), personal computer(s), smart phone(s), laptop(s), notebook(s), etc. In certain embodiments a remote computing device 106 may not comprise each of the elements described with respect to FIG. 34. Some embodiments may comprise multiple instances of remote computing devices 106, third party computing devices 104, and user computing devices 102. In some embodiments a Saas (Software as a Service) or other enterprise software platform 3499 (e.g., CRM (Customer Relationship Management) tools; HRM (Human Resource Management) tools; HRIS (Human Resource Information System) tools; and other similar platforms or software) can comprise all or portions of any of remote computing devices 106, third party computing devices 104, and user computing devices 102. Enterprise platform 3499 can comprise software used for tracking customer relationships, including: contact information, sales data, industry information, sales histories, client data such as size, sales goals, and other data. Enterprise platform 3499 can also comprise software for predicting future sales, accounting tools, tax software, or other tools. An instance of enterprise platform 3499 operating on e.g., remote computing devices 106 may be able to be mirrored and/or to communicate with instances of enterprise platform 3499 on user computing devices 102 and/or third party computing devices 104, and vice versa. As illustrated, the remote computing device 106, which includes a processor 3430, input/output hardware 3432, network interface hardware 3434, a data storage component 3436 (which stores assessment data 3438a, team data 3438b, and/or other data), and the memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the remote computing device 106 and/or external to the remote computing device 106.

The memory component 140 may store operating logic 3442, the compiling logic 144a and the analyzing logic 144b. The compiling logic 144a and the analyzing logic 144b may each include a plurality of different pieces of logic, each of which may be embodied as a computer program, firmware, and/or hardware, as an example. A local interface 3446 is also included in FIG. 34 and may be implemented as a bus or other communication interface to facilitate communication among the components of the remote computing device 106.

The processor 3430 may include any processing component operable to receive and execute instructions (such as from a data storage component 3436 and/or the memory component 140). The input/output hardware 3432 may include and/or be configured to interface with microphones, speakers, a display, and/or other hardware.

The network interface hardware 3434 may include and/or be configured for communicating with any wired or wireless networking hardware, including an antenna, a modem, LAN port, wireless fidelity (Wi-Fi) card, WiMax card, Bluetooth chip, USB card, mobile communications hardware, and/or other hardware for communicating with other networks and/or devices. From this connection, communication may be facilitated between the remote computing device 106 and other computing devices, such as the user computing device 102.

The operating logic 3442 may include an operating system and/or other software for managing components of the remote computing device 106. As also discussed above, the compiling logic 144a may reside in the memory component 140 and may be configured to cause the processor 3430 to compile a plurality of different behavioral assessments that were performed on a plurality of different individuals. Similarly, the analyzing logic 144b may be utilized to cause the processor 3430 to perform analysis on the behavioral assessments, provide the user interfaces depicted herein; and provide other functionality described herein.

It should be understood that while the components in FIG. 34 are illustrated as residing within the remote computing device 106, this is merely an example. In some embodiments, one or more of the components may reside external to the remote computing device 106. It should also be understood that, while the remote computing device 106 is illustrated as a single device, this is also merely an example. In some embodiments, the compiling logic 144a and the analyzing logic 144b may reside on different computing devices. As an example, one or more of the functionality and/or components described herein may be provided by the third party computing device 104 and/or user computing device 102, which may be coupled to the remote computing device 106 via the network 100.

Additionally, while the remote computing device 106 is illustrated with the compiling logic 144a and the analyzing logic 144b as separate logical components, this is also an example. In some embodiments, a single piece of logic may cause the remote computing device 106 to provide the described functionality.

As illustrated above, various embodiments for processing behavioral assessments are disclosed. These embodiments may allow a user to construct a virtual team of people and assess the strengths and weaknesses of the team as a whole or individually. Embodiments may additionally recommend other team members, and predicts effects of including new people into a team. These embodiments provide new calculations and analysis to uniquely combine information from behavioral assessments; provide new calculations and analysis to compare team members and/or potential new team members; provide new calculations and analysis to recommend job hires; and/or provide other calculations and analysis described herein, which provide significantly more than what is conventional in the art.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for processing behavioral assessments. It should also be understood that these embodiments are merely exemplary and are not intended to limit the scope of this disclosure.

Remote computing device 106 (or in some embodiments user computing device 102) can perform ML-based methods such as described further below, for optimizing or choosing enterprise team formation, creating and choosing roles within enterprises/teams, sales efforts by teams, or other methods as described herein. Certain embodiments of the present disclosure include machine learning processes for selecting sales team or other team initiatives; or selecting individuals to serve in certain roles. In certain embodiments remote computing device 106 can comprise, e.g., in data storage 3436 of FIG. 34, a ML/AI engine for training or implementing a ML/AI model. The architecture of an ML model (e.g., structure, number of layers, nodes per layer, activation function etc.) may need to be tailored for each particular use case. For example, properties to vary can include e.g. personality measures/assessments; specific roles within enterprises or teams; enterprise type or industry; client; multiple teams assigned to a given client; company goals and/or results such as sales goals; retention measures and/or other data which can impact optimization of team or enterprise performance. These may all need to be considered when designing the ML model's architecture.

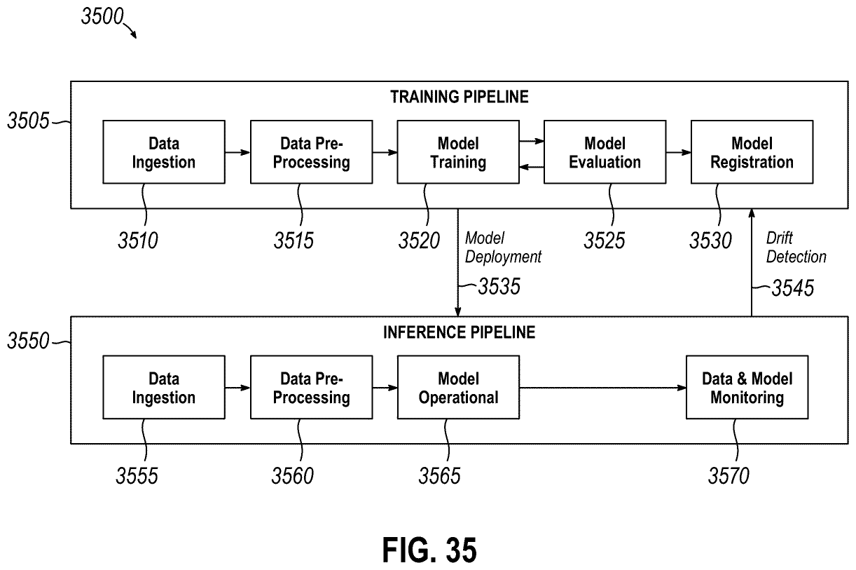

Building an AI/ML model includes several development steps where the actual training of the ML model is just one step in a training pipeline. An important part in AI/ML development is the AI/ML model lifecycle management. One embodiment 3500 of a model lifecycle management procedure 3500 is illustrated in FIG. 35. The model lifecycle management comprises two pipelines: a training pipeline 3505 and an inference pipeline 3550.

At a first step in the training pipeline 3505, data ingestion 3510 occurs, which includes gathering raw (training) data from a data storage (e.g., data storage 3436, assessment data 3438a, and/or team data 3438b of FIG. 34). Certain data can come from e.g., enterprise platform 3499, such as sales data, sales goals, etc. After data ingestion 3510, there may also be a step that controls the validity of the gathered data. At 3515 data pre-processing occurs, which can include feature engineering applied to the gathered data. This may involve, e.g., data normalization or data formatting or transformation required for the input data to the AI/ML model. After the ML model's architecture is fixed, it should be trained on one or more datasets. At 3520 model training is performed in which the AI/ML model is trained with the raw training data. To achieve good performance during live operation in a system (the so-called inference phase), the training datasets should be representative of actual data the ML model will encounter during live operation. The training process often involves numerically tuning the ML model's trainable parameters (e.g., the weights and biases of the underlying neural network (NN)) to minimize a loss function on the training datasets. The loss function may be, for example, based on a measurable goal for a team or enterprise, e.g., a sales goal or a retention measurement. The purpose of the loss function is to meaningfully quantify the reconstruction error for the particular use case at hand. At 3525 model evaluation can be performed where the performance is benchmarked to some baseline. Model training 3520 and evaluation 3525 can be iterated until an acceptable level of performance is achieved. At 3530 model registration occurs, in which the AI/ML model is registered with any corresponding data on how the AI/ML model was developed, and e.g., AI/ML model evaluation data. At 3535 model deployment occurs, wherein the trained/re-trained AI/ML model is implemented in the inference pipeline 3550.

Data ingestion 3555 in the inference pipeline 3550 refers to gathering raw (inference) data from a data source storage (e.g., data storage 3436, assessment data 3438a, and/or team data 3438b of FIG. 34). Data pre-processing 3560 can be essentially identical/similar to the data pre-processing 3515 of the training pipeline 3505. At 3565, the operational model received from the training pipeline 3505 is used to process new data received during operation of e.g., remote computing device(s) 106 of FIG. 34 or FIG. 1 or user computing device 104 of FIG. 1. At 3570 data and model monitoring is performed. Here the inference data is analyzed to determine whether the inference data are from a distribution that aligns with the training data, as well as monitoring model outputs for detecting any performance, or operational, variance or drifts. The variance or drift is used at 3545 (drift detection) to update the AI/ML model registration.

The training process is typically based on some variant of a gradient descent algorithm, which, at its core, comprises three components: a feedforward step, a back propagation step, and a parameter optimization step. These steps can be described using a dense ML model (i.e., a dense NN with a bottleneck layer) as an example.

Feedforward: A batch of training data, such as a mini-batch, (e.g., several downlink-channel estimates) is pushed through the ML model, from the input to the output. The loss function is used to compute the reconstruction loss for all training samples in the batch. The reconstruction loss may be an average reconstruction loss for all training samples in the batch.

The feedforward calculations of a dense ML model with N layers (n=1, 2, . . . , N) may be written as follows: The output vector a^{[n]} of layer n is computed from the output of the previous layer a^{[n-1]} using the equations:

$${z}^{[ n ]} = {W}^{[ n ]} \cdot {a}^{[ n - 1 ]} + {b}^{[ n ]} , {a}^{[ n ]} = g ( {z}^{[ n ]} ) \qquad ( 1 )$$

In the above equation, W^{[n]} and b^{[n]} are the trainable weights and biases of layer n, respectively, and g is an activation function applied elementwise (for example, a rectified linear unit).

Back propagation (BP): The gradients (partial derivatives of the loss function, L, with respect to each trainable parameter in the ML model) are computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n+1.

For a dense ML model with N layers the back propagation calculations for layer n may be expressed with the following well-known equations:

$$\frac{\partial L}{\partial {a}^{[ n ]}} = {[ {W}^{[ n + 1 ]} ]}^{T} \cdot \frac{\partial L}{\partial {z}^{[ n + 1 ]}} \qquad ( 2 )$$

$$\frac{\partial L}{\partial {z}^{[ n ]}} = \frac{\partial L}{\partial {a}^{[ n ]}} * {g}^{{[ n ]}^{′}} ( {z}^{[ n ]} ) \qquad ( 3 )$$

$$\frac{\partial L}{\partial {W}^{[ n ]}} = \frac{\partial L}{\partial {z}^{[ n ]}} \cdot {[ {a}^{[ n - 1 ]} ]}^{T} \qquad ( 4 )$$

$$\frac{\partial L}{\partial {b}^{[ n ]}} = \frac{\partial L}{\partial {z}^{[ n ]}} \qquad ( 5 )$$

where * here denotes the Hadamard multiplication of two vectors.

Parameter optimization: The gradients computed in the back propagation step are used to update the ML model's trainable parameters. An approach is to use the gradient descent method with a learning rate hyperparameter (α) that scales the gradients of the weights and biases, as illustrated by the following update equations:

$${W}^{[ n ]} = {W}^{[ n ]} - α \cdot \frac{\partial L}{\partial {w}^{[ n ]}} \qquad ( 6 )$$

$${b}^{[ n ]} = {b}^{[ n ]} - α \cdot \frac{\partial L}{\partial {b}^{[ n ]}} \qquad ( 7 )$$

It is preferred to make small adjustments to each parameter with the aim of reducing the average loss over the (mini) batch. It is common to use special optimizers to update the ML model's trainable parameters using gradient information. The following optimizers are widely used to reduce training time and improve overall performance: adaptive sub-gradient methods (AdaGrad), RMSProp, and adaptive moment estimation (ADAM), but use of other optimizers is possible.

The above process (feedforward, back propagation, parameter optimization) is repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined value chosen by a user.

In some implementations, a function F(⋅) may be generated by a ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware described in remote computing device of FIG. 34 or user computing device of FIG. 1 (e.g., in the form of simple vector-matrix multiplications).

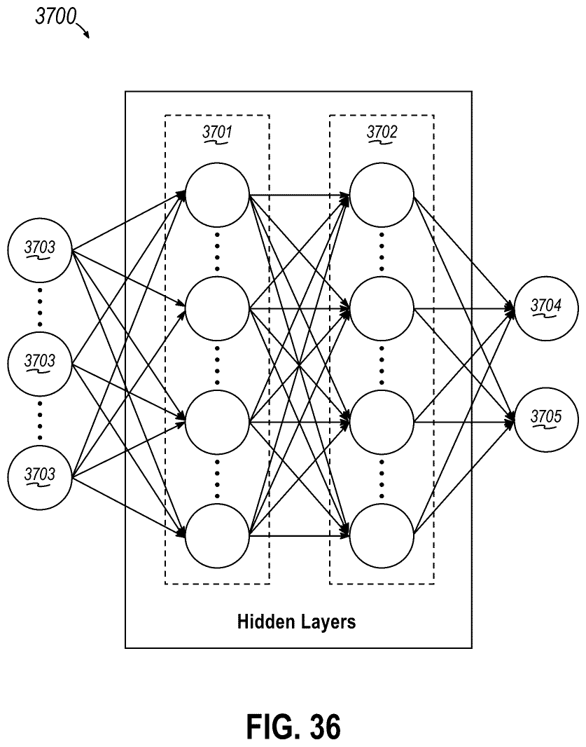

Referring now to FIG. 36, an example NN 3700 (e.g., DNN) is shown. In some implementations, and as shown, the neural network 3700 may include two hidden layers represented by dashed boxes 3701 and 3702. In one implementation, the inputs 3703 may be fed into the neural network 3700. Next, the inputs 3703 may go through a set of hidden layers (e.g., 3701 and/or 3702). Once the inputs 3703 pass though the hidden layers 3701 and/or 3702, they may be output (e.g., as an output layer) as e.g., sales totals 3704; team conflict/success measurement 3705; or another output valuable for enterprise, HR, or team analysis, such as e.g., changes to employment status, changes to roles, performance reviews, performance ratings, engagement survey results, learning strategies, management or leadership approaches. Possible inputs can include e.g., personality assessment data, personality types, team role, team formation, industry type, changes to employment status, changes to roles, performance reviews, performance ratings, engagement survey results, or a myriad of other tracked data.

As should be understood by one of ordinary skill in the art, in order for the NN 3700 to output a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

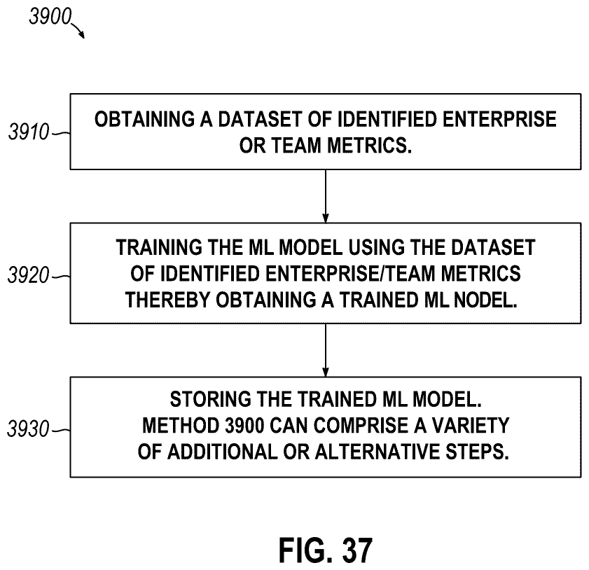

Another possible embodiment of a method under the present disclosure is shown in FIG. 37. Method 3900 is a computer implemented method for training a machine learning model for optimizing one or more enterprise or team outcomes. Step 3910 is obtaining a dataset of identified enterprise or team metrics. Step 3920 is training the ML model using the dataset of identified enterprise/team metrics thereby obtaining a trained ML model. Step 3930 is storing the trained ML model. Method 3900 can comprise a variety of additional or alternative steps. For example, it can further comprise inference steps, such as obtaining a dataset of optimized enterprise/team tactics or metrics by the trained model by inputting a dataset of enterprise/team tactics/metrics into the trained model, wherein the dataset of enterprise/team tactics/metrics comprises one or more of: one or more personality assessments; one or more personality assessments compared to each other; one or more sales outcomes; one or more profitability metrics; one or more retention metrics; and one or more enterprise/team outcomes related to any of the foregoing. The dataset of identified enterprise metrics can comprise a variety of things, such as inputs/outputs identified above, including comprising one or more of: text based coaching strategies e.g. for managing through change, dealing with change, leading team members with different styles, identifying the source of strategies to overcome conflict, motivation and persuasion strategies, communication and collaboration concepts that will be most effective for the team assembled.

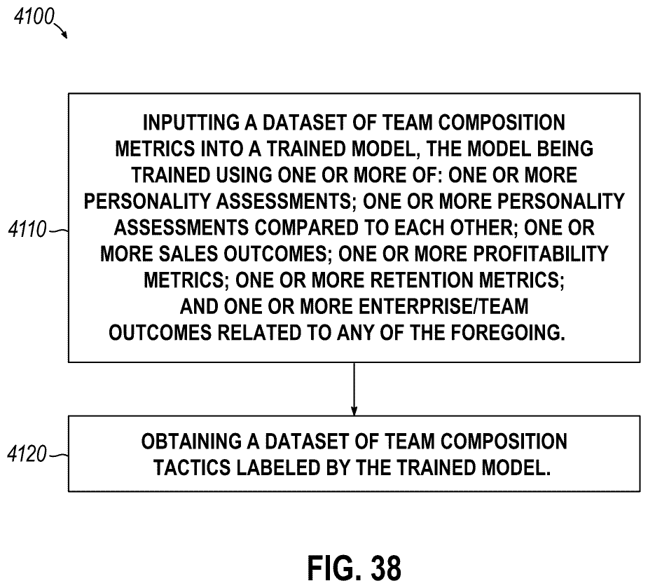

Another possible embodiment of a method under the present disclosure is shown in FIG. 38. Method 4100 is a computer implemented method for obtaining optimized team composition. Step 4110 is inputting a dataset of team composition metrics into a trained model, the model being trained using one or more of: one or more personality assessments; one or more personality assessments compared to each other; one or more sales outcomes; one or more profitability metrics; one or more retention metrics; and one or more enterprise/team outcomes related to any of the foregoing. Step 4120 is obtaining a dataset of team composition tactics labeled by the trained model. Method 4100 can comprise multiple alternative embodiments with additional or alternative steps.

Inputs 3703 and outputs 3704, 3705 for neural network 3700, or data for training pipeline 3505 or inference pipeline 3550, or as used in methods 3900 or 4100, can take a variety of forms. Common inputs or other data might be team or individual behavior assessments or personality tests, team size, team composition, specific clients or industries, sales tactics, or other variables. Outputs or other data could be results such as sales outcomes, customer feedback or complaints, quarterly success metrics, enterprise growth, stock price, or other data related to results. All of these variables or results can be valuable in training ML models or improving enterprise metrics or tactics. The results or trained ML models may be used to improve enterprise tactics or to improve products, software and other embodiments under the present disclosure.

### Abbreviated List of Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

As used herein, directional terms, such as “top,” “bottom,” “left,” “right,” “up,” “down,” “upper,” “lower,” “proximal,” “distal,” “adjacent,” and the like are used herein solely to indicate relative directions and are not otherwise intended to limit the scope of the disclosure and/or claimed invention.

### CONCLUSION

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention itemed. Thus, it should be understood that although the present invention has been specifically disclosed in part by preferred embodiments, exemplary embodiments, and optional features, modification and variation of the concepts herein disclosed may be resorted to by those skilled in the art, and such modifications and variations are considered to be within the scope of this invention as defined by the appended items. The specific embodiments provided herein are examples of useful embodiments of the present invention and various alterations and/or modifications of the inventive features illustrated herein, and additional applications of the principles illustrated herein that would occur to one skilled in the relevant art and having possession of this disclosure, can be made to the illustrated embodiments without departing from the spirit and scope of the invention as defined by the items and are to be considered within the scope of this disclosure.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

All references cited in this application are hereby incorporated in their entireties by reference to the extent that they are not inconsistent with the disclosure in this application. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques specifically described herein are intended to be encompassed by this invention.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. All changes which come within the meaning and range of equivalency of the items are to be embraced within their scope.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim:

1. A system for training a machine learning model for optimizing one or more team outcomes:
a computing device that stores logic that, when executed by a processor of the computing device, causes the system to perform at least the following:
obtain a dataset of identified team metrics;
train a ML model using the dataset of identified team metrics thereby obtaining a trained ML model; and
store the trained ML model.

2. The system of claim 1, wherein the logic causes the system to perform the additional step:
obtain a dataset of optimized team metrics by the trained model by inputting a dataset of team metrics into the trained model.

3. The system of claim 1, wherein the dataset of identified team metrics comprises one or more of: one or more personality assessments; one or more sales outcomes; one or more profitability metrics; one or more retention metrics; a first behavioral assessment assessing a first behavioral characteristic of a first person; a second behavioral assessment assessing a second behavioral characteristic of the first person; a behavioral parameter for the first person based at least in part on the first behavioral characteristic and the second behavioral characteristic; a comparison of the behavioral parameter against corresponding behavioral parameters for respective persons for a team to determine how the first person would work with the respective persons; a desired dynamic for the team; a hypothetical scenario dataset, wherein the hypothetical scenario dataset describes how the first person would work with the respective persons of the team; an impact of including the first person in the team, based on the desired dynamic for the team and the hypothetical scenario dataset.

4. The system of claim 3, wherein the behavioral parameter includes a score for at least one of the following regarding the first person: personality, culture, strength, skills and competences, and a role of the first person.

5. The system of claim 3, wherein the dataset of identified team metrics comprises one or more of:
(a) a first person rating for the first person;
(b) a team rating for the team; and
(c) a comparison of the first person rating with the team rating.

6. The system of claim 3, wherein the logic further causes the system to create team roles for the team, wherein the team roles are based on the corresponding behavioral parameters for the respective persons of the team.

7. The system of claim 3, wherein the logic further causes the system to provide an option to define desired behavioral characteristics of a team that includes the first person, and wherein the logic further causes the system to obtain a dataset of optimized desired behavioral characteristics by the trained model by inputting a dataset of team metrics into the trained model, wherein the dataset of team metrics comprises one or more behavioral characteristics.

8. The system of claim 3, wherein the logic further causes the system to calculate a behavioral parameter for the first behavioral assessment of a team that includes the first person.

9. A computer implemented method for training a machine learning model for optimizing one or more enterprise outcomes, comprising:
obtaining a dataset of identified enterprise metrics, wherein the dataset of identified enterprise metrics comprises one or more personality assessments;
training a ML model using the dataset of identified enterprise metrics thereby obtaining a trained ML model; and
storing the trained ML model.

10. The method of claim 9, further comprising;
inputting a dataset of enterprise metrics into the trained model resulting in a dataset of optimized enterprise metrics.

11. The method of claim 9, wherein the dataset of identified enterprise metrics comprises one or more of: data from a Customer Relationship Management, CRM, platform; one or more customer feedback; one or more personality assessments; one or more sales outcomes; one or more profitability metrics; one or more retention metrics; a first behavioral assessment assessing a first behavioral characteristic of a first person; a second behavioral assessment assessing a second behavioral characteristic of the first person; a behavioral parameter for the first person based at least in part on the first behavioral characteristic and the second behavioral characteristic; a comparison of the behavioral parameter against corresponding behavioral parameters for respective persons for a team to determine how the first person would work with the respective persons; a desired dynamic for the team; a hypothetical scenario dataset, wherein the hypothetical scenario dataset describes how the first person would work with the respective persons of the team; an impact of including the first person in the team, based on the desired dynamic for the team and the hypothetical scenario dataset; data from a Human Capital Management, HCM, platform; data from a Human Resource Information System, HRIS, platform.

12. The method of claim 11, wherein the behavioral parameter includes a score for at least one of the following regarding the first person: personality, culture, strength, skills and competences, and a role of the first person.

13. The method of claim 11, further comprising;
providing to a user an option to define desired behavioral characteristics of a team that includes the first person;
inputting a dataset of enterprise metrics into the trained model, wherein the dataset of enterprise metrics comprises one or more behavioral characteristics; and
obtaining a dataset of optimized desired behavioral characteristics from the trained model.

14. The method of claim 9, wherein the dataset of identified enterprise metrics comprise one or more of: text based coaching strategies e.g. for managing through change, dealing with change, leading team members with different styles, identifying the source of strategies to overcome conflict, motivation and persuasion strategies, communication and collaboration concepts that will be most effective for the team assembled.

15. The method of claim 11, further comprising:
calculating a behavioral parameter for the first behavioral assessment of a team that includes the first person.

16. The method of claim 11, further comprising creating team roles for the team, wherein the team roles are based on the corresponding behavioral parameters for the respective persons of the team.

17. The method of claim 11, further comprising calculating a relationship map that indicates relationships among the respective persons of the team based on relationship criteria, wherein the relationship criteria may reside along a continuum between conflict and agreement.

18. A computer implemented method for obtaining optimized team composition, comprising:
inputting a dataset of team composition metrics into a trained model, the model being trained using one or more personality assessments; and
obtaining a dataset of team composition tactics labeled by the trained model.

19. The method of claim 18, wherein the logic further causes the system to provide an actionable insight on at least one person.

20. The method of claim 18, further comprising providing an option to define desired behavioral characteristics of a team that includes a first person.
